(19) United States
(12) Patent Application Publication
(10) Pub. No.: US 2009/0081510 A1
(43) Pub. Date: Mar. 26, 2009

(54) SUPPORTED CATALYST, METHOD FOR MANUFACTURING SUPPORTED CATALYST, FUEL CELL, AND METHOD FOR MANUFACTURING FUEL CELL

(75) Inventors: Naoya Hayamizu, Kanagawa-ken (JP); Yukihiro Shibata, Fukuoka-ken (JP); Masashi Yamage, Kanagawa-ken (JP); Jun Momma, Kanagawa-ken (JP); Hideo Oota, Tokyo (JP)

Correspondence Address: PEARNE & GORDON LLP, 1801 EAST 9TH STREET, SUITE 1200, CLEVELAND, OH, 44114-3108, US

(73) Assignee: KABUSHIKI KAISHA TOSHIBA, Tokyo (JP)

(21) Appl. No.: 12/239,066

(22) Filed: Sep. 26, 2008

(30) Foreign Application Priority Data
Sep. 26, 2007 (JP) 2007-250033
Feb. 6, 2008 (JP) 2008-027076

(51) Int. Cl. H01M 4/88; H01M 4/96; B01J 27/20; B01J 31/02; H01M 4/08

(52) U.S. Cl. 429/27; 502/174; 502/101; 502/168; 502/150

(57) ABSTRACT

A supported catalyst includes: a catalyst; and a carbon body. The catalyst is supported on the carbon body, and the carbon body is linear.

### CROSS-REFERENCE TO RELATED APPLICATIONS

This application is based upon and claims the benefit of priority from the prior Japanese Patent Application No. 2007-250033, filed on Sep. 26, 2007; No. 2008-027076, filed on Feb. 6, 2008; the entire contents of which are incorporated herein by reference.

### BACKGROUND OF THE INVENTION

1. Field of the Invention

This invention relates to a supported catalyst, a method for manufacturing a supported catalyst, a fuel cell, and a method for manufacturing a fuel cell.

2. Background Art

With the recent progress of electronics, electronic devices have become smaller, more powerful, and more portable, and cells used therein increasingly need downsizing and higher energy density. In this context, fuel cells, which have high capacity although small and lightweight, are attracting attention. In particular, as compared with fuel cells based on hydrogen gas, the direct methanol fuel cell (DMFC) using methanol as its fuel is free from difficulty in handling hydrogen gas and needs no systems for reforming an organic fuel to produce hydrogen. Thus, DMFC is suitable for downsizing.

Such a direct methanol fuel cell has a fuel electrode (anode), a polymer solid electrolyte membrane, and an air electrode (cathode) provided in this order adjacent to each other to form a membrane electrode assembly. A fuel (methanol) is supplied to the fuel electrode side and reacted in a catalyst layer on the fuel electrode side near the polymer solid electrolyte membrane to produce protons (H⁺) and electrons (e⁻). On the other hand, at a catalyst layer on the air electrode side near the polymer solid electrolyte membrane, protons (H⁺) which have permeated through the polymer solid electrolyte membrane react with electrons (e⁻) conducted to the air electrode side and air (oxygen) to produce water.

Here, improvement of cell characteristics greatly depends on the production of protons (H⁺) and electrons (e⁻) by the reaction at the catalyst on the fuel electrode side and the supply of the protons (H⁺) and electrons (e⁻) to the catalyst on the air electrode side. That is, an important factor is to enhance the migration of protons (H⁺) and electrons (e⁻) at the catalyst layer.

To this end, some catalyst supports having increased proton (H⁺) conductivity are proposed (see JP-T-2005-527957 (Kohyo) and JP-A-2005-150002 (Kokai)).

However, in the techniques disclosed in JP-T-2005-527957 (Kohyo) and JP-A-2005-150002 (Kokai), no consideration is given to the contact between the catalyst support and the external conductor at the interface of the catalyst layer and the contact between the catalyst supports, and there is a possibility that the migration enhancement of electrons (e⁻) cannot be achieved.

Furthermore, in the case where a particulate carbon material is used as the catalyst support, the particulate carbon material may aggregate in the process of manufacturing the catalyst layer. Aggregation of the particulate carbon material results in decreased surface area of the catalyst support and deteriorated air permeability. Unfortunately, this decreases the catalyst utilization efficiency, and hence the power generation efficiency.

A technique is proposed to solve this problem, in which a catalyst supporting particle, a fibrous material, and an electrolyte material (binder) are granulated to produce a catalyst powder (see JP-A-2007-250366 (Kokai)).

However, in the technique disclosed in JP-A-2007-250366 (Kokai), the surface area of the portion supporting the catalyst cannot be increased. Furthermore, it may be difficult to realize a uniform distribution of gaps (interstices). Hence, there remains room for improvement in the enhancement of catalyst utilization efficiency. Furthermore, there is also a possibility of complicating the manufacturing process and increasing cost.

### SUMMARY OF THE INVENTION

According to an aspect of the invention, there is provided a supported catalyst including: a catalyst; and a carbon body, the catalyst being supported on the carbon body, and the carbon body being linear.

According to another aspect of the invention, there is provided a supported catalyst including: a catalyst; a linear first carbon body supporting the catalyst; and a linear second carbon body, one end of the first carbon body being electrically connected to the second carbon body.

According to another aspect of the invention, there is provided a supported catalyst including: a catalyst; a linear first carbon body supporting the catalyst; and a particulate second carbon body, one end of the first carbon body being electrically connected to the second carbon body.

According to another aspect of the invention, there is provided a supported catalyst configured in a layer structure, including: a catalyst; a linear first carbon body supporting the catalyst; and a second carbon body, one end of the first carbon body being electrically connected to the second carbon body, and part of the second carbon body reaching a surface of the layer structure.

According to another aspect of the invention, there is provided a method for manufacturing a supported catalyst, including: attaching a first catalyst metal particle on a surface of a conductor; forming a linear first carbon body on a surface of the first catalyst metal particle; and allowing the first carbon body to support a catalyst.

According to another aspect of the invention, there is provided a method for manufacturing a supported catalyst, including: attaching a first catalyst metal particle on a surface of a first carbon body; forming a linear second carbon body on a surface of the first catalyst metal particle; allowing the second carbon body to support a catalyst; and immersing the first carbon body and the second carbon body in a solid polymer electrolyte solution.

According to another aspect of the invention, there is provided a method for manufacturing a supported catalyst, including: forming a first catalyst metal layer on a surface of a conductor; granulating the first catalyst metal layer by heating treatment; forming a linear first carbon body on a surface of the granulated first catalyst metal layer; and allowing the first carbon body to support a catalyst.

According to another aspect of the invention, there is provided a method for manufacturing a supported catalyst, including: forming a silicon layer on a surface of a conductor; forming a catalyst metal layer on a surface of the silicon layer; granulating the silicon layer and the catalyst metal layer by heating treatment; forming a linear carbon body on a surface of the granulated layers; and allowing the carbon body to support a catalyst.

According to another aspect of the invention, there is provided a method for manufacturing a supported catalyst, including: forming a catalyst metal layer on a surface of a first carbon body or an aggregate of the first carbon bodies; granulating the catalyst metal layer by heating treatment; forming a linear second carbon body on a surface of the granulated catalyst metal layer; allowing the second carbon body to support a catalyst; and immersing the first carbon body and the second carbon body in a solid polymer electrolyte solution.

According to another aspect of the invention, there is provided a method for manufacturing a supported catalyst, including: forming a silicon layer on a surface of a first carbon body or an aggregate of the first carbon bodies; forming a catalyst metal layer on a surface of the silicon layer; granulating the silicon layer and the catalyst metal layer by heating treatment; forming a linear second carbon body on a surface of the granulated layers; allowing the second carbon body to support a catalyst; and immersing the first carbon body and the second carbon body in a solid polymer electrolyte solution.

According to another aspect of the invention, there is provided a fuel cell including: a fuel electrode to be supplied with a fuel; an air electrode to be supplied with an oxidizer; and a polymer solid electrolyte membrane sandwiched between the fuel electrode and the air electrode, at least one of supported catalysts provided respectively on the fuel electrode and the air electrode being the supported catalyst described above.

According to another aspect of the invention, there is provided a method for manufacturing a fuel cell, the fuel cell including a fuel electrode to be supplied with a fuel, an air electrode to be supplied with an oxidizer, and a polymer solid electrolyte membrane sandwiched between the fuel electrode and the air electrode, the method including: manufacturing at least one of supported catalysts provided respectively on the fuel electrode and the air electrode by the method for manufacturing a supported catalyst described above.

### BRIEF DESCRIPTION OF THE DRAWINGS

FIG. 1 is a schematic view of a layer structure for illustrating a supported catalyst according to a first embodiment of the invention;

FIGS. 2A and 2B are schematic views of a layer structure for illustrating a supported catalyst according to a second embodiment of the invention;

FIGS. 3A and 3B are schematic views of a layer structure for illustrating a supported catalyst according to a third embodiment of the invention;

FIGS. 4A and 4B are schematic views of a layer structure for illustrating a supported catalyst according to a fourth embodiment of the invention;

FIG. 5 is a flow chart for illustrating a method for manufacturing a supported catalyst according to a fifth embodiment of the invention;

FIG. 6 is a flow chart for illustrating a method for manufacturing a supported catalyst according to a sixth embodiment of the invention;

FIG. 7 is a flow chart for illustrating a method for manufacturing a supported catalyst according to a seventh embodiment of the invention;

FIG. 8 is a schematic cross-sectional view of a layer structure for illustrating a conductor with a catalyst metal layer formed thereon;

FIG. 9 is a schematic view of a plasma processing apparatus capable of growing an ultrafine fibrous carbon body;

FIGS. 10A and 10B are schematic views for illustrating a carbon body including a nucleus made of a catalyst metal;

FIG. 11 is a schematic view for illustrating a plasma processing apparatus provided with a shield;

FIG. 12 is a flow chart for illustrating a method for manufacturing a supported catalyst according to an eighth embodiment of the invention;

FIG. 13 is a schematic cross-sectional view of a layer structure for illustrating a conductor with a silicon layer and a catalyst metal layer formed thereon;

FIG. 14 is a flow chart for illustrating a method for manufacturing a supported catalyst according to a ninth embodiment of the invention;

FIGS. 15A to 15C are schematic views for illustrating growth of a carbon body;

FIG. 16 is a schematic view for illustrating a fuel cell according to a tenth embodiment of the invention; and

FIG. 17 is a flow chart for illustrating a method for manufacturing a fuel cell according to an eleventh embodiment of the invention.

### DETAILED DESCRIPTION OF THE INVENTION

Embodiments of the invention will now be illustrated with reference to the drawings.

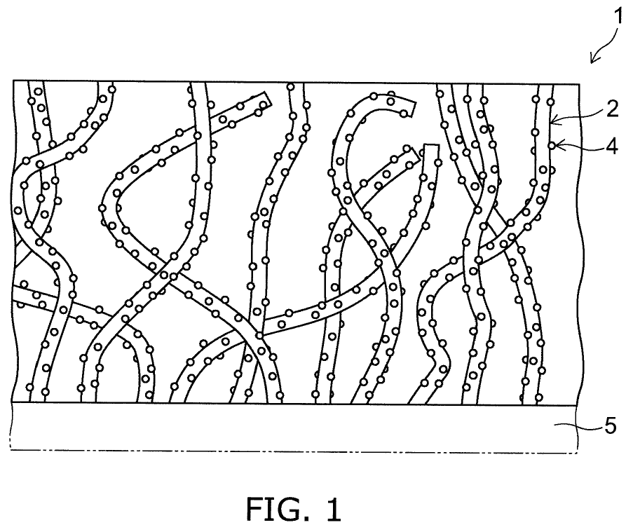

FIG. 1 is a schematic view of a layer structure for illustrating a supported catalyst according to a first embodiment of the invention.

For convenience of description, by way of example, this embodiment is described with reference to the case where the surface of the carbon body 2 is modified to be able to conduct protons (H⁺).

As shown in FIG. 1, the catalyst layer 1 includes a catalyst 4 and a carbon body 2 made of ultrafine fibrous carbon bodies. The catalyst 4 is supported on the surface of the carbon body 2. One end of the ultrafine fibrous carbon body 2 reaches the surface of the catalyst layer 1 and is joined to the surface of a conductor 5 (e.g., a carbon paper serving as a gas diffusion layer described below) provided at the interface of the catalyst layer 1.

It is also possible to configure the conductor (e.g., the conductor 5 described above) as part of the catalyst layer (e.g., the catalyst layer 1 described above). In that case, the catalyst layer can be connected to an external member (e.g., the gas diffusion layer described below) via the conductor 5. Here, the conductor 5, which is part of the catalyst layer, is made of a conductive material, and can illustratively be a carbon paper. This also applies to the other embodiments illustrated below.

The ultrafine fibrous carbon body 2 can illustratively be a carbon nanotube, a carbon nanofiber, a graphite nanofiber, a tubular graphite, a carbon nanocone with a sharp tip, and a conical graphite. It is noted that FIG. 1 shows the case where the carbon body 2 is a carbon nanotube. The ultrafine fibrous carbon body 2 is not limited to the foregoing, but can be suitably changed.

Furthermore, the surface of the carbon body 2 is modified to be able to conduct protons (H⁺). Such surface modification can be realized illustratively by modifying the surface of the carbon body 2 with a substituent group capable of supplying protons by dissociation. This surface modification illustratively includes sulfonization of the surface of the carbon body 2. Furthermore, for example, at least one substituent group selected from the group consisting of a carboxyl group, a sulfonyl group, an amino group, a nitro group, and a sulfo group can be provided directly, or via an organic structure, on the surface of the carbon body 2.

The following chemical formula 1 represents the case of providing a sulfo group directly on the surface of the carbon body 2, and chemical formula 2 represents the case of providing a sulfo group on the surface of the carbon body 2 via an organic structure.

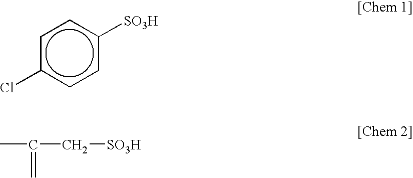

In the case where the catalyst layer 1 is a catalyst layer on the fuel electrode side, the catalyst 4 only needs to be able to oxidize an organic fuel, and can illustratively include a solid solution of platinum with at least one metal selected from the group consisting of iron, nickel, cobalt, tin, ruthenium, and gold.

In the case where the catalyst layer 1 is a catalyst layer on the air electrode side, the catalyst 4 only needs to cause a reduction reaction, and can illustratively include a platinum-group element. For example, it can include an elemental metal such as platinum, ruthenium, rhodium, iridium, osmium, and palladium, and a solid solution containing a platinum-group element. The solid solution containing a platinum-group element can illustratively be a platinum-nickel solid solution. However, the invention is not limited thereto, but the material can be suitably modified.

Here, the power generation efficiency can be improved by increasing the contact probability between the carbon body and the conductor at the interface of the catalyst layer to facilitate migration of electrons (e⁻).

As a result of study, the inventors have found that the power generation efficiency can be improved by allowing one end of the ultrafine fibrous carbon body 2 to reach the surface of the catalyst layer and can be joined to the surface of the conductor 5, where migration of electrons (e⁻) can then be ensured.

Because the ultrafine fibrous carbon body 2 can be longitudinally elongated, it can be provided so as to connect between the end faces of the catalyst layer 1. Hence, migration of electrons (e⁻) between the inside and the end face of the catalyst layer 1 can be further ensured.

Furthermore, even if the end face of some of the carbon bodies 2 is not in contact with the end face of the catalyst layer 1, they are in contact with another carbon body 2 at a portion on their outer surface, and hence they can be in indirect contact with the end face of the catalyst layer 1 through the other carbon body 2. That is, because the carbon bodies 2 are longitudinally elongated, they are entangled with each other into a network on which electrons (e⁻) can migrate. Moreover, the number of carbon bodies 2 isolated in the catalyst layer 1 can be significantly reduced.

Because the catalyst 4 is supported on the surface of such carbon body 2 that can ensure migration of electrons (e⁻), electrons (e⁻) can be passed more reliably in the vicinity of the catalyst 4. Hence, the amount of wasted catalyst 4 failing to pass electrons (e⁻) can be reduced. Thus, the utilization efficiency of the catalyst 4, and hence the power generation efficiency, can be improved.

Furthermore, despite the mutual entanglement, the aggregation as in the particulate carbon material can be prevented. Hence, because gaps can be maintained, interference with the supply of oxygen and the organic fuel can be prevented. Consequently, the utilization efficiency of the catalyst, and hence the power generation efficiency, can be improved.

Furthermore, the inventors have found that more preferable power generation efficiency can be achieved if the carbon body 2 has a center diameter of 1 micrometer or more and 10 micrometers or less.

Furthermore, the carbon bodies can be linked to each other with a binder. The mechanical strength of the catalyst layer 1 can be improved by linking the carbon bodies to each other with a binder. If the binder is primarily composed of a proton conductive material, the proton conductivity can be further improved. The binder primarily composed of a proton conductive material can illustratively be a polymer solid electrolyte material such as a fluorine-based resin having a sulfonic acid group (e.g., a perfluorosulfonic acid polymer) and a hydrocarbon-based resin having a sulfonic acid group. However, the invention is not limited thereto, but the material can be suitably modified.

As described above, according to this embodiment, the conduction path of electrons (e-) to the catalyst 4 can be formed more reliably.

Furthermore, because aggregation of carbon bodies can be prevented, oxygen and the organic fuel can be reliably supplied. Moreover, the surface area of the portion supporting the catalyst 4 can be increased.

Furthermore, by surface modification of the carbon body 2, the conduction path of protons (H⁺) can be effectively formed.

Hence, the utilization efficiency of the catalyst 4 can be improved, and stable power generation at high output can be realized.

Furthermore, because the conduction path of protons (H⁺) is formed by surface modification of the carbon body 2, it is possible to provide stable power generation with little temporal variation, being resistant to the effect of expansion and shrinkage associated with changes in temperature and other external environment.

For convenience of description, this embodiment has been illustrated with reference to the case where the surface of the carbon body 2 is modified. However, a carbon body without surface modification can also be used. Also in that case, because aggregation of carbon bodies can be prevented, gaps can be maintained, and oxygen and the organic fuel can be reliably supplied. Moreover, the surface area of the portion supporting the catalyst 4 can be increased. Furthermore, also in this case, one end of the carbon body 2 reaches the surface of the catalyst layer 1 and is joined to the surface of the conductor 5 (e.g., a carbon paper serving as a gas diffusion layer described below) provided at the interface of the catalyst layer 1. Hence, migration of electrons (e⁻) can be facilitated. Thus, the utilization efficiency of the catalyst, and hence the power generation efficiency, can be improved.

However, if surface modification is performed so that protons (H⁺) can be conducted, the conduction path of protons (H⁺) can be effectively formed as described above. Furthermore, it is possible to provide stable power generation with little temporal variation, being resistant to the effect of expansion and shrinkage associated with changes in temperature and other external environment.

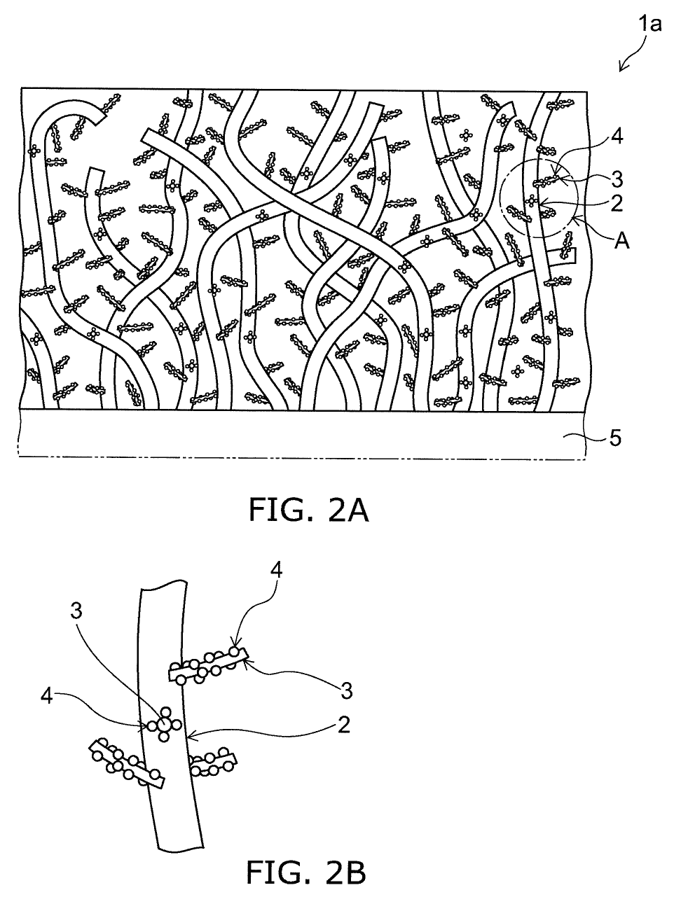

FIG. 2 is a schematic view of a layer structure for illustrating a supported catalyst according to a second embodiment of the invention.

Here, FIG. 2A is a schematic cross-sectional view of the catalyst layer, and FIG. 2B is a schematic partial enlarged view of portion A in FIG. 2A. The same portions as those described with reference to FIG. 1 are labeled with like reference numerals, and the description thereof is omitted.

For convenience of description, by way of example, this embodiment is described with reference to the case where the surface of the carbon body is modified to be able to conduct protons (H⁺).

As shown in FIGS. 2A and 2B, the catalyst layer 1a includes a catalyst 4, a carbon body 2 made of ultrafine fibrous carbon bodies, and a carbon body 3 made of ultrafine fibrous carbon bodies smaller (having a smaller thickness and a shorter length) than the carbon bodies 2. The carbon body 3 is joined to the surface of the carbon body 2 (here, at least electrical connection is formed between the carbon body 2 and the carbon body 3), and the catalyst 4 is supported on the surface of the carbon body 3. Furthermore, one end of the carbon body 2 reaches the surface of the catalyst layer 1a and is joined to the surface of a conductor 5 (e.g., a carbon paper serving as a gas diffusion layer described below) provided at the interface of the catalyst layer 1a.

Like the carbon body 2, the ultrafine fibrous carbon body 3 can illustratively be a carbon nanotube, a carbon nanofiber, a graphite nanofiber, a tubular graphite, a carbon nanocone with a sharp tip, and a conical graphite. It is noted that FIG. 2 shows the case where the carbon body 3 is a carbon nanotube. The ultrafine fibrous carbon body 3 is not limited to the foregoing, but can be suitably changed.

Here, the power generation efficiency can be improved by increasing the amount of catalyst contained in the catalyst layer. The amount of catalyst can be increased by increasing the surface area of the carbon body (support) supporting the catalyst, and it can be achieved by minimizing the size of the carbon body.

However, if the size of the carbon body is decreased so that the catalyst layer is composed of only small carbon bodies, the number of carbon bodies failing to be in contact with other carbon bodies and isolated in the catalyst layer increases. In this case, the isolated carbon body cannot contribute to the passage of electrons (e⁻). Hence, the catalyst supported on the isolated carbon body cannot serve its function and is wasted.

As a result of study, the inventors have found that the number of small carbon bodies 3 isolated in the catalyst layer 1a can be reduced by providing a carbon body 2 having a large size (large in thickness and length) and a small carbon body 3 (small in thickness and length) joined to the surface of the carbon body 2 (here, at least electrical connection is formed between the carbon body 2 and the carbon body 3). If the number of small carbon bodies 3 isolated in the catalyst layer 1a can be reduced, electrons (e⁻) can be passed also in the vicinity of the catalyst 4 supported thereon. Thus, the utilization efficiency of the catalyst 4, and hence the amount and efficiency of power generation, can be improved.

In this embodiment, the catalyst layer 1a includes a carbon body 2 having a large size and a small carbon body 3 joined to the surface of the carbon body 2 (here, at least electrical connection is formed between the carbon body 2 and the carbon body 3). As described above, because the carbon bodies 2 are longitudinally elongated, they are entangled with each other, and the number of carbon bodies 2 isolated in the catalyst layer 1a can be significantly reduced. Hence, also with regard to the small carbon bodies 3 joined to the surface of the carbon bodies 2, the number of carbon bodies 3 isolated in the catalyst layer 1a can be significantly reduced. Furthermore, one end of the carbon body 2 reaches the surface of the catalyst layer 1a and is joined to the surface of the conductor 5 (e.g., a carbon paper serving as a gas diffusion layer described below) provided at the interface of the catalyst layer 1a.

Hence, electrons (e⁻) can be reliably passed in the vicinity of the catalyst 4 through the carbon body 2 and the carbon body 3. Furthermore, because the amount of wasted catalyst 4 can be reduced, the utilization efficiency of the catalyst 4, and hence the power generation efficiency, can be improved.

Furthermore, by providing a small carbon body 3, the area (surface area) supporting the catalyst 4 can be extended, and the amount of catalyst 4 can be increased by that amount.

Furthermore, despite the mutual entanglement, the aggregation as in the particulate carbon material can be prevented. In this case, because the small carbon body 3 is joined to the surface of the carbon body 2 having a large size, aggregation can be prevented more effectively. Hence, because gaps can be maintained more reliably, the supply of oxygen and the organic fuel can be further facilitated. Consequently, the utilization efficiency of the catalyst, and hence the power generation efficiency, can be further improved.

Furthermore, the inventors have found that more preferable power generation efficiency can be achieved if the carbon body 2 has a center diameter of 1 micrometer or more and 10 micrometers or less and the carbon body 3 has a center particle diameter of 100 nanometers or less.

Furthermore, as described above, the surface of the carbon body 2 is modified to be able to conduct protons (H⁺). As described above, such surface modification can be realized illustratively by modifying the surface of the carbon body 2 with a substituent group capable of supplying protons by dissociation.

Furthermore, if the surface of the carbon body 3 is also modified to be able to conduct protons (H⁺), proton conduction in the vicinity of the catalyst 4 can be performed more reliably.

Surface modification of the carbon body 3 can be realized illustratively by modifying the surface of the carbon body 3 with a substituent group capable of supplying protons by dissociation. This surface modification illustratively includes sulfonization of the surface of the carbon body 3. Furthermore, for example, at least one substituent group selected from the group consisting of a carboxyl group, a sulfonyl group, an amino group, a nitro group, and a sulfo group can be provided directly, or via an organic structure, on the surface of the carbon body 3.

For example, the above chemical formula 1 represents the case of providing a sulfo group directly on the surface, and chemical formula 2 represents the case of providing a sulfo group on the surface via an organic structure.

Furthermore, the carbon bodies can be linked to each other with a binder. The mechanical strength of the catalyst layer 1a can be improved by linking the carbon bodies to each other with a binder. If the binder is primarily composed of a proton conductive material, the proton conductivity can be further improved. The binder primarily composed of a proton conductive material can illustratively be a polymer solid electrolyte material such as a fluorine-based resin having a sulfonic acid group (e.g., a perfluorosulfonic acid polymer) and a hydrocarbon-based resin having a sulfonic acid group. However, the invention is not limited thereto, but the material can be suitably modified.

As described above, according to this embodiment, the conduction path of electrons (e⁻) to the catalyst 4 can be formed more reliably.

Furthermore, because aggregation of carbon bodies can be prevented more effectively, oxygen and the organic fuel can be supplied more reliably.

Furthermore, by surface modification of the carbon body 2, the conduction path of protons (H⁺) can be effectively formed. Furthermore, by providing a carbon body 3 having a small size, the area (surface area) supporting the catalyst 4 can be extended, and the amount of catalyst 4 can be increased by that amount. Furthermore, by surface modification of the carbon body 3, proton conduction in the vicinity of the catalyst 4 can be performed more reliably. Hence, the utilization efficiency of the catalyst 4 can be improved, and stable power generation at high output can be realized.

Furthermore, because the conduction path of protons (H⁺) is formed by surface modification of the carbon body, it is possible to provide stable power generation with little temporal variation, being resistant to the effect of expansion and shrinkage associated with changes in temperature and other external environment.

For convenience of description, this embodiment has been illustrated with reference to the case where the surface of the carbon body is modified. However, a carbon body without surface modification can also be used. Because this embodiment uses a carbon body 3 having a small size, aggregation of carbon bodies can be prevented more effectively. Moreover, the surface area of the portion supporting the catalyst 4 can be further increased.

Also in this case, one end of the carbon body 2 reaches the surface of the catalyst layer 1a and is joined to the surface of the conductor 5 (e.g., a carbon paper serving as a gas diffusion layer described below) provided at the interface of the catalyst layer 1a. Hence, migration of electrons (e⁻) can be facilitated. Thus, the utilization efficiency of the catalyst, and hence the power generation efficiency, can be improved.

However, if surface modification is performed so that protons (H⁺) can be conducted, the conduction path of protons (H⁺) can be effectively formed as described above. Furthermore, it is possible to provide stable power generation with little temporal variation, resistant to the effect of expansion and shrinkage associated with changes in temperature and other external environment.

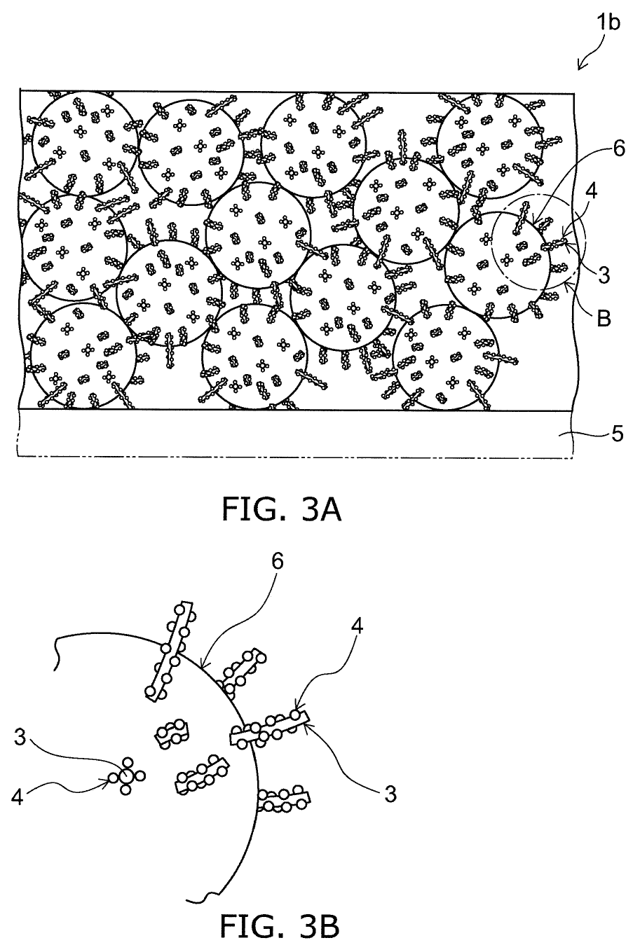

FIG. 3 is a schematic view of a layer structure for illustrating a supported catalyst according to a third embodiment of the invention.

Here, FIG. 3A is a schematic cross-sectional view of the catalyst layer, and FIG. 3B is a schematic partial enlarged view of portion B in FIG. 3A. The same portions as those described with reference to FIGS. 1 and 2 are labeled with like reference numerals, and the description thereof is omitted.

For convenience of description, by way of example, this embodiment is described with reference to the case where the surface of the carbon body is modified to be able to conduct protons (H⁺).

As shown in FIGS. 3A and 3B, the catalyst layer 1b includes a catalyst 4, a carbon body 6 made of particulate carbon bodies, and a carbon body 3 made of ultrafine fibrous carbon bodies having a smaller size than the carbon bodies 6. The carbon body 3 is joined to the surface of the carbon body 6 (here, at least electrical connection is formed between the carbon body 3 and the carbon body 6), and the catalyst 4 is supported on the surface of the carbon body 3. Furthermore, the outer surface of at least some of the carbon bodies 6 provided near the interface of the catalyst layer 1b is in contact with the surface of a conductor 5 (e.g., a carbon paper serving as a gas diffusion layer described below) provided at the interface of the catalyst layer 1b.

The carbon body 6 can be made of a particulate carbon-based material, which can illustratively be a carbon black such as channel black, furnace black, lamp black, thermal black, and acetylene black (carbon fine particles industrially manufactured under quality control). It is noted that carbon blacks are not limited to the foregoing, but can be suitably changed.

As described above, in order to extend the surface area of the carbon body (support) supporting the catalyst, if the size of the carbon body is decreased so that the catalyst layer is composed of only small carbon bodies, the number of carbon bodies failing to be in contact with other carbon bodies and isolated in the catalyst layer increases. In this case, the isolated carbon body cannot contribute to the passage of electrons (e⁻). Hence, the catalyst supported on the isolated carbon body cannot serve its function and is wasted.

In this embodiment, the catalyst layer 1b includes a large-particle-diameter carbon body 6. In this case, the carbon bodies 6 are provided adjacent to each other because they have a large size. Thus, at least some of the carbon bodies 6 are in contact with each other at a portion of the outer surfaces thereof. In fact, typically, most of the carbon bodies 6 are in contact with each other at a portion of the outer surfaces thereof. Hence, the number of carbon bodies isolated in the catalyst layer 1b can be significantly reduced.

Because the carbon body 3 supporting the catalyst 4 is joined to the surface of the carbon body 6 (here, at least electrical connection is formed between the carbon body 3 and the carbon body 6), electrons (e⁻) can be passed in the vicinity of the catalyst 4 through the carbon body 6 and the carbon body 3.

Thus, because the amount of wasted catalyst 4 can be reduced, the utilization efficiency of the catalyst 4, and hence the power generation efficiency, can be improved. Furthermore, by providing a carbon body 3 having a small size, the area (surface area) supporting the catalyst 4 can be extended, and the amount of catalyst 4 can be increased by that amount.

Furthermore, in this embodiment, the ultrafine fibrous carbon body 3 is provided on the surface of the particulate carbon body 6. Hence, excessive aggregation of carbon bodies 6 can be prevented. Thus, because suitable gaps can be maintained therebetween, the supply of oxygen and the organic fuel can be facilitated. Consequently, the utilization efficiency of the catalyst, and hence the power generation efficiency, can be improved.

Furthermore, the inventors have found that more preferable power generation efficiency can be achieved if the carbon body 6 has a center particle diameter of 1 micrometer or more and 10 micrometers or less and the carbon body 3 has a center particle diameter of 100 nanometers or less.

Furthermore, the surface of the carbon body 6 is modified to be able to conduct protons (H⁺). Such surface modification can be realized illustratively by modifying the surface of the carbon body 6 with a substituent group capable of supplying protons by dissociation. This surface modification illustratively includes sulfonization of the surface of the carbon body 6. Furthermore, for example, at least one substituent group selected from the group consisting of a carboxyl group, a sulfonyl group, an amino group, a nitro group, and a sulfo group can be provided directly, or via an organic structure, on the surface of the carbon body 6.

For example, the above chemical formula 1 represents the case of providing a sulfo group directly on the surface, and chemical formula 2 represents the case of providing a sulfo group on the surface via an organic structure.

Furthermore, if the surface of the carbon body 3 is also modified to be able to conduct protons (H⁺), proton conduction in the vicinity of the catalyst 4 can be performed more reliably.

Surface modification of the carbon body 3 can be realized illustratively by modifying the surface of the carbon body 3 with a substituent group capable of supplying protons by dissociation. This surface modification illustratively includes sulfonization of the surface of the carbon body 3. Furthermore, for example, at least one substituent group selected from the group consisting of a carboxyl group, a sulfonyl group, an amino group, a nitro group, and a sulfo group can be provided directly, or via an organic structure, on the surface of the carbon body 3.

For example, the above chemical formula 1 represents the case of providing a sulfo group directly on the surface, and chemical formula 2 represents the case of providing a sulfo group on the surface via an organic structure.

Furthermore, the carbon bodies can be linked to each other with a binder. The mechanical strength of the catalyst layer 1b can be improved by linking the carbon bodies to each other with a binder. If the binder is primarily composed of a proton conductive material, the proton conductivity can be further improved. The binder primarily composed of a proton conductive material can illustratively be a polymer solid electrolyte material such as a fluorine-based resin having a sulfonic acid group (e.g., a perfluorosulfonic acid polymer) and a hydrocarbon-based resin having a sulfonic acid group. However, the invention is not limited thereto, but the material can be suitably modified.

As described above, according to this embodiment, the conduction path of electrons (e⁻) to the catalyst 4 can be formed more reliably.

Furthermore, because excessive aggregation of carbon bodies can be prevented, oxygen and the organic fuel can be supplied reliably.

Furthermore, by surface modification of the carbon body 6, the conduction path of protons (H⁺) can be effectively formed. Furthermore, by providing a carbon body 3 having a small size, the area (surface area) supporting the catalyst 4 can be extended, and the amount of catalyst 4 can be increased by that amount. Furthermore, by surface modification of the carbon body 3, proton conduction in the vicinity of the catalyst 4 can be performed more reliably. Hence, the utilization efficiency of the catalyst 4 can be improved, and stable power generation at high output can be realized.

Furthermore, because the conduction path of protons (H⁺) is formed by surface modification of the carbon body, it is possible to provide stable power generation with little temporal variation, being resistant to the effect of expansion and shrinkage associated with changes in temperature and other external environment.

For convenience of description, this embodiment has been illustrated with reference to the case where the surface of the carbon body is modified. However, a carbon body without surface modification can also be used. In this embodiment, because the ultrafine fibrous carbon body 3 is provided on the surface of the particulate carbon body 6, excessive aggregation of carbon bodies 6 can be prevented. Moreover, the surface area of the portion supporting the catalyst 4 can be further increased.

Also in this case, the outer surface of at least some of the carbon bodies 6 is in contact with the surface of the conductor 5 (e.g., a carbon paper serving as a gas diffusion layer described below) provided at the interface of the catalyst layer 1b. Hence, migration of electrons (e⁻) can be facilitated. Thus, the utilization efficiency of the catalyst, and hence the power generation efficiency, can be improved.

However, if surface modification is performed so that protons (H⁺) can be conducted, the conduction path of protons (H⁺) can be effectively formed as described above. Furthermore, it is possible to provide stable power generation with little temporal variation, being resistant to the effect of expansion and shrinkage associated with changes in temperature and other external environment.

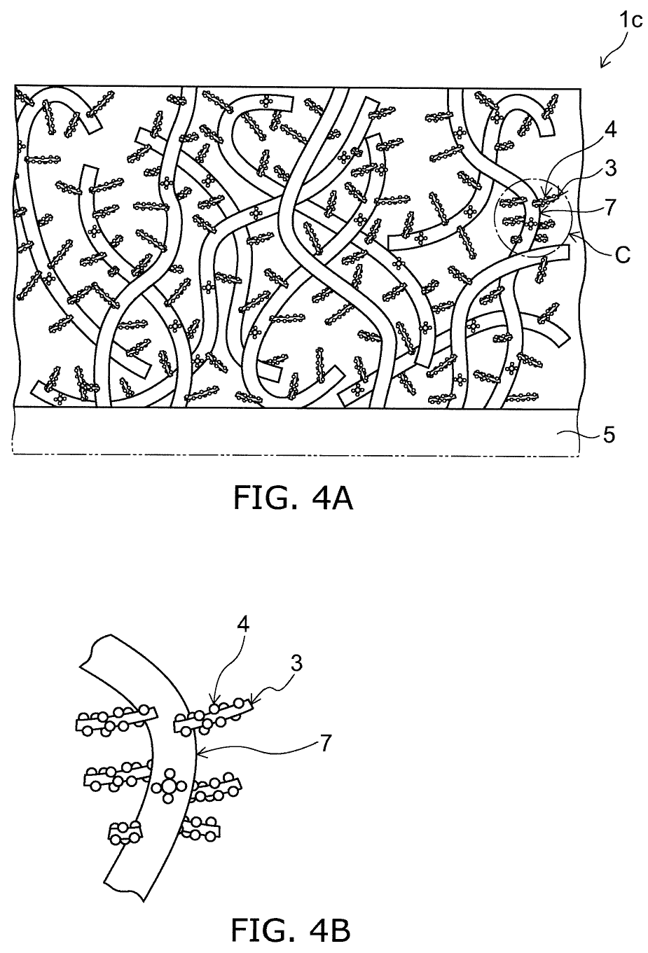

FIG. 4 is a schematic view of a layer structure for illustrating a supported catalyst according to a fourth embodiment of the invention.

Here, FIG. 4A is a schematic cross-sectional view of the catalyst layer, and FIG. 4B is a schematic partial enlarged view of portion C in FIG. 4A. The same portions as those described with reference to FIGS. 1 and 2 are labeled with like reference numerals, and the description thereof is omitted.

For convenience of description, by way of example, this embodiment is described with reference to the case where the surface of the carbon body is modified to be able to conduct protons (H⁺).

As shown in FIGS. 4A and 4B, the catalyst layer 1c includes a catalyst 4, a carbon body 7 made of ultrafine fibrous carbon bodies, and a carbon body 3 made of ultrafine fibrous carbon bodies having a smaller size than the carbon bodies 7. One end of the carbon body 3 is joined to the surface of the carbon body 7 (here, at least electrical connection is formed between the carbon body 3 and the carbon body 7), and the catalyst 4 is supported on the surface of the carbon body 3. Furthermore, the outer surface of at least some of the carbon bodies 7 provided near the interface of the catalyst layer 1c is in contact with the surface of a conductor 5 (e.g., a carbon paper serving as a gas diffusion layer described below) provided at the interface of the catalyst layer 1c. Furthermore, the surface of the carbon body 7 is modified to be able to conduct protons (H⁺). The surface of the carbon body 3 can also be modified to be able to conduct protons (H⁺). It is also possible to link the carbon bodies to each other with a binder.

The ultrafine fibrous carbon body 7 can illustratively be a carbon nanotube, a carbon nanofiber, a graphite nanofiber, a tubular graphite, a carbon nanocone with a sharp tip, and a conical graphite. It is noted that FIG. 4 shows the case where the carbon body 7 is a carbon nanotube. The ultrafine fibrous carbon body 7 is not limited to the foregoing, but can be suitably changed.

The catalyst layer 1c shown in FIG. 4 is different from the catalyst layer 1b described with reference to FIG. 3 in that the particulate carbon body 6 of the catalyst layer 1b is replaced by the ultrafine fibrous carbon body 7. In this case, the carbon bodies 7 are provided adjacent to each other because they have a large size. Thus, at least some of the carbon bodies 7 are entangled in contact with each other at a portion of the outer surfaces thereof. In fact, typically, most of the carbon bodies 7 are in contact with each other at a portion of the outer surfaces thereof. Hence, like the carbon bodies 6 described with reference to FIG. 3, the number of carbon bodies isolated in the catalyst layer 1c can be significantly reduced.

Other functions and effects are the same as those of the catalyst layer 1b described with reference to FIG. 3, and hence the description thereof is omitted.

The case of the carbon body without surface modification is also the same as that described with reference to FIG. 3, and hence the description thereof is omitted.

Next, a method for manufacturing a supported catalyst according to an embodiment of the invention is illustrated.

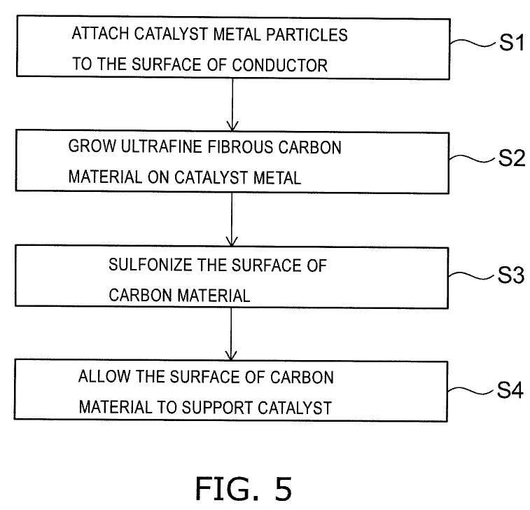

FIG. 5 is a flow chart for illustrating a method for manufacturing a supported catalyst according to a fifth embodiment of the invention.

For convenience of description, modification of the surface of the carbon body with a substituent group capable of supplying protons by dissociation is exemplified by sulfonization of the surface of the carbon body. Furthermore, the following description is given with reference to the case illustrated in FIG. 1.

First, catalyst metal particles (e.g., cobalt, nickel, iron, or an alloy based on at least one of them) are formed in a particulate configuration on the surface of a conductor 5 (e.g., a carbon paper serving as a gas diffusion layer described below) (step S1).

The catalyst metal particles can be attached illustratively by sputtering or electroless plating.

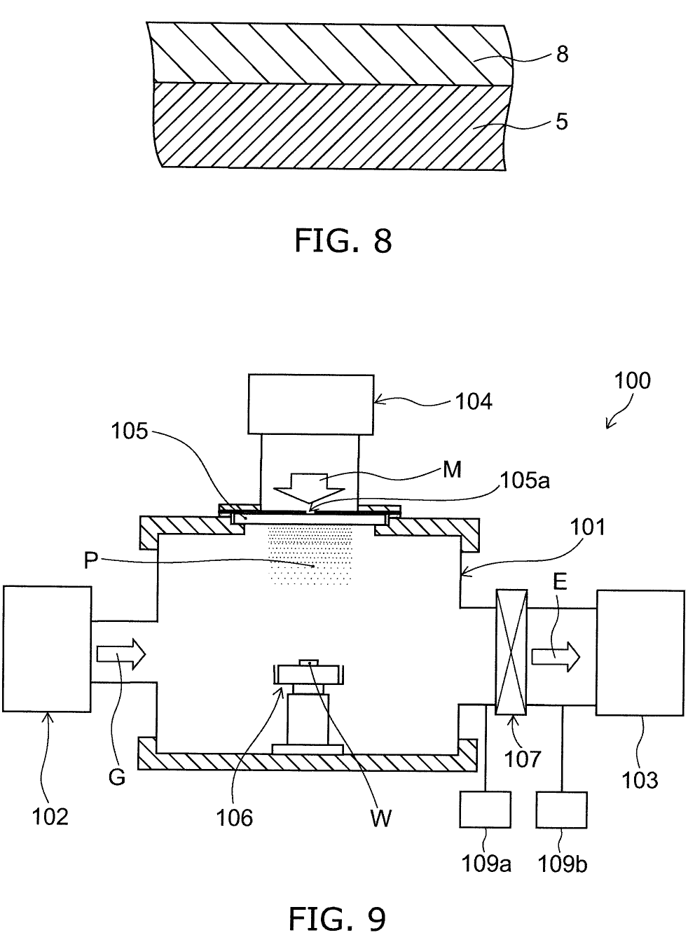

Alternatively, as described below, a catalyst metal layer 8 (see FIG. 8) can be formed by sputtering or electroless plating and turned into metal particles by heating treatment.

Then, an ultrafine fibrous carbon body 2 (e.g., carbon nanotube) is grown on the surface of the catalyst metal using plasma CVD (chemical vapor deposition), for example (step S2).

Here, in plasma CVD, for example, tetraethoxysilane can be used as a source gas to generate a plasma in a hydrogen reducing atmosphere so that an ultrafine fibrous carbon body 2 is grown on the surface of the catalyst metal.

Thus, because the carbon body 2 is grown on the surface of the catalyst metal particle attached to the surface of the conductor 5, one end of the carbon body 2 is allowed to reach the surface of the catalyst layer via the catalyst metal particle and can be joined to the surface of the conductor 5.

Next, the surface of the carbon body 2 is sulfonized (step S3).

The surface of the carbon body 2 can be sulfonized illustratively by the following methods.

Firstly, the surface of the carbon body 2 can be directly sulfonized by using fuming sulfuric acid. In this method, first, a carbon black having a prescribed center particle diameter is immersed and stirred in an oil bath at 120° C. under a nitrogen atmosphere. Next, 30% fuming sulfuric acid is dropped thereto, the reaction is continued for approximately 6 hours, and then the mixture is left standing to cool to room temperature. The reaction liquid is poured into purified water, and the precipitate is filtered. It is washed with purified water until pH reaches approximately 5 to 6, and vacuum-dried under an atmosphere at 60° C. Thus, a carbon body 2 having a sulfonized surface can be obtained. Alternatively, the temperature of the oil bath can be 140° C., and the time of reaction with 30% fuming sulfuric acid can be approximately 48 hours.

Secondly, the surface of the carbon body 2 can be directly sulfonized by using sodium sulfite. In this method, first, a carbon black having a prescribed center particle diameter, sodium sulfite, and dimethylacetamide are immersed and stirred in an oil bath at 120° C. under a nitrogen atmosphere, and the reaction is continued for approximately 72 hours. Next, the reaction liquid is poured into diethyl ether and precipitated. The produced precipitate is washed with ethanol and vacuum-dried under an atmosphere at 60° C. Thus, a carbon body 2 having a sulfonized surface can be obtained.

Thirdly, the surface of the carbon body 2 can be sulfonized via an organic structure by using a sulfonized monomer (sulfonized 4,4′-difluorobenzophenone). In this method, first, a carbon black having a prescribed center particle diameter, sulfonized 4,4′-difluorobenzophenone, potassium carbonate, and a solvent (dimethylacetamide, toluene) are stirred under a nitrogen atmosphere at room temperature for approximately 1 hour. Next, it is immersed and stirred in an oil bath at 150° C., and the reaction is continued for approximately 3 hours. Then, it is returned to room temperature, and added with 18-crown-6. Next, it is immersed again in an oil bath at 160° C., and the reaction is continued for approximately 72 hours. This reaction product is reprecipitated in acetone, washed with purified water, and then vacuum-dried under an atmosphere at 80° C. Thus, a carbon body 2 having a surface sulfonized via an organic structure can be obtained.

Here, a method for producing sulfonized 4,4′-difluorobenzophenone is illustrated. 4,4′-difluorobenzophenone is immersed in an oil bath at 160° C. under a nitrogen atmosphere to melt the monomer. Then, the temperature of the oil bath is decreased to 120° C., and the oil bath is stirred. Next, 30% fuming sulfuric acid is dropped thereto for approximately 30 minutes, and the reaction is continued for approximately 6 hours. Then, the mixture is left standing to cool to room temperature. The reaction liquid is poured into saturated saline, and a precipitate is obtained by salting out and filtration. Next, this precipitate is dissolved into water and adjusted so that pH is approximately 8. Then, it is poured again into saturated saline for salting out. The crude sulfonized product thus obtained is recrystallized in a solution of 2-propanol/water=70/30 (weight %). This recrystallization is repeated three times, and the product is vacuum-dried under an atmosphere at 60° C. Thus, sulfonized 4,4′-difluorobenzophenone can be obtained.

It is noted that the sulfonization method is not limited to the foregoing, but can be suitably changed.

Furthermore, in the case where surface modification is not needed, step S3 is unnecessary.

Next, the surface of the conductor 5 to which the carbon body 2 is joined is immersed in a solution dispersed with fine particles of the catalyst 4 so that the catalyst 4 is supported on the surface of the carbon body 2 (step S4).

Then, by drying it at room temperature, a desired catalyst layer 1 can be obtained.

It is noted that the carbon body 2 supporting the catalyst 4 can be immersed in a solid polymer electrolyte solution (e.g., a solution of Nafion®, available from DuPont) to link the carbon bodies to each other with the binder described above. In this case, the solid polymer electrolyte (e.g., Nafion®, available from DuPont) in the solution serves as the binder described above.

In the case illustrated in FIG. 2, that is, in the case where the ultrafine fibrous carbon body 3 is further joined to the surface of the carbon body 2 (here, at least electrical connection is formed between the carbon body 2 and the carbon body 3), after the growth of the carbon body 2 described above (step S2), catalyst metal particles can be formed in a particulate configuration on the surface of the carbon body 2, and the ultrafine fibrous carbon body 3 can be grown on the surface of the catalyst metal. In this case, only the surface of the carbon body 2 can be sulfonized if sulfonization is performed before the growth of the carbon body 3. Alternatively, the surface of the carbon body 2 and the carbon body 3 can be sulfonized if sulfonization is performed after the growth of the carbon body 3.

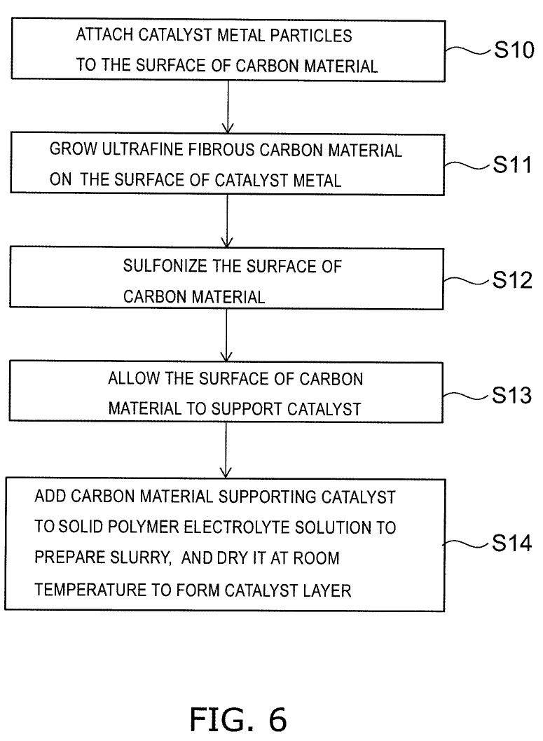

FIG. 6 is a flow chart for illustrating a method for manufacturing a supported catalyst according to a sixth embodiment of the invention.

What is illustrated in FIG. 6 is the case of manufacturing the catalyst layer 1b, 1c illustrated in FIGS. 3 and 4. That is, it is the case of manufacturing the catalyst layer 1b in which an ultrafine fibrous carbon body 3 is joined to the surface of a particulate carbon body 6 (here, at least electrical connection is formed between the carbon body 3 and the carbon body 6), and the case of manufacturing the catalyst layer 1c in which an ultrafine fibrous carbon body 3 is joined to the surface of an ultrafine fibrous carbon body 7 (here, at least electrical connection is formed between the carbon body 3 and the carbon body 7).

Also in these cases, modification of the surface of the carbon body with a substituent group capable of supplying protons by dissociation is exemplified by sulfonization of the surface of the carbon body.

First, catalyst metal particles (e.g., cobalt, nickel, iron, or an alloy containing at least one of them) are attached in a particulate configuration to the surface of a carbon body 6 or carbon body 7 (step S10).

The catalyst metal particles can be attached illustratively by sputtering or electroless plating. The carbon body 6 itself can be a commercially available carbon black, and the carbon body 7 itself can be a commercially available ultrafine fibrous carbon body (e.g., carbon nanotube).

Then, an ultrafine fibrous carbon body 3 (e.g., carbon nanotube) is grown on the surface of the catalyst metal using plasma CVD (chemical vapor deposition), for example (step S11).

Here, in plasma CVD, for example, tetraethoxysilane can be used as a source gas to generate a plasma in a hydrogen reducing atmosphere so that an ultrafine fibrous carbon body 3 is grown on the surface of the catalyst metal.

Thus, because the carbon body 3 is grown on the surface of the catalyst metal particle attached to the surface of the carbon body 6 or carbon body 7, one end of the carbon body 3 can be joined to the surface of the carbon body 6 or carbon body 7 (here, at least electrical connection is formed between the carbon body 3 and the carbon body 6, and between the carbon body 3 and the carbon body 7).

Next, the surface of the carbon body 3 and the carbon body 6, or the carbon body 3 and the carbon body 7, is sulfonized (step S12).

The method for sulfonization is the same as that described above, and hence the description thereof is omitted.

Furthermore, in the case where surface modification is not needed, step S12 is unnecessary.

Next, the surface of the carbon body 6 or carbon body 7 to which the carbon body 3 is joined is immersed in a solution dispersed with fine particles of the catalyst 4 so that the catalyst 4 is supported on the surface of the carbon body 3 (step S13).

In this case, the catalyst 4 is supported also on the surface of the carbon body 6 or carbon body 7.

Next, the carbon body 3 and 6 or the carbon body 3 and 7 supporting the catalyst 4 is added to a solid polymer electrolyte solution (e.g., a solution of Nafion®, available from DuPont) and mixed in a homogenizer to prepare a slurry. The catalyst layer 1b or catalyst layer 1c is obtained by drying this slurry at room temperature (step S14).

In this case, the solid polymer electrolyte (e.g., Nafion® from DuPont) in the slurry serves as the binder described above. It is also possible to apply this slurry to a conductor 5 (e.g., a carbon paper serving as a gas diffusion layer described below) and dry it at room temperature.

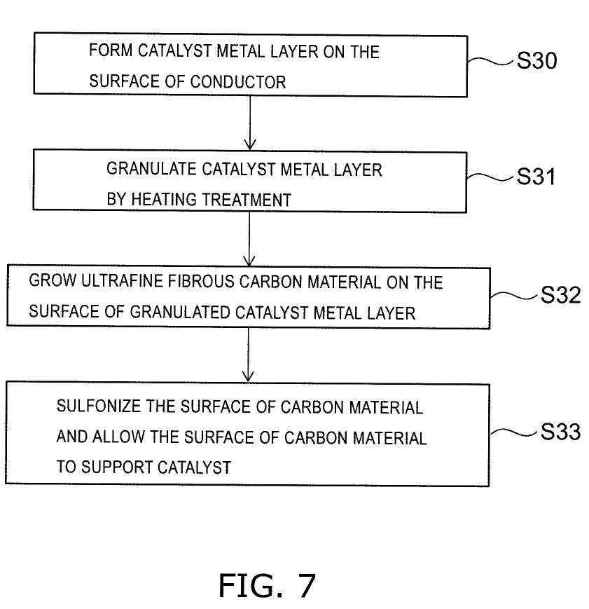

FIG. 7 is a flow chart for illustrating a method for manufacturing a supported catalyst according to a seventh embodiment of the invention.

FIG. 8 is a schematic cross-sectional view of a layer structure for illustrating a conductor with a catalyst metal layer formed thereon.

FIG. 9 is a schematic view of a plasma processing apparatus capable of growing an ultrafine fibrous carbon body.

First, a plasma processing apparatus 100 is described.

As shown in FIG. 9, the plasma processing apparatus 100 comprises a container 101 capable of maintaining a reduced-pressure environment therein, a gas supply means 102 for supplying a material gas G into the container 101, an evacuation means 103 for evacuating E the container 101, a microwave generation means 104 for oscillating a microwave M toward the container 101, a dielectric window 105 having a slot 105a for transmitting the microwave M, a mounting stage 106 for mounting and holding a workpiece W, and a control valve 107 provided between the container 101 and the evacuation means 103 for controlling the pressure in the container 101. The mounting stage 106 includes a temperature adjustment means 12, not shown, for adjusting the temperature of the workpiece W. The temperature adjustment means, not shown, can illustratively be a heater for heating the workpiece W. Furthermore, pressure monitors 109a, 109b are provided on the container 101 side and the evacuation means 103 side of the control valve 107, respectively. The control valve 107 is controlled on the basis of the output from the pressure monitors 109a, 109b.

The plasma processing apparatus 100 can perform plasma CVD (chemical vapor deposition) processing and includes a control means, not shown, capable of controlling processing conditions such as pressure, gas switching, gas flow rate, RF power, heater temperature, and processing time.

Each element and its function of the plasma processing apparatus 100 can be based on known techniques, and hence the detailed description thereof is omitted.

Next, returning to FIG. 7, a method for manufacturing a catalyst layer is illustrated.

Like the embodiment illustrated in FIG. 5, this embodiment illustrates a method for manufacturing a catalyst layer 1, 1a. Hence, the description of the same elements as those in FIG. 5 is omitted as appropriate.

First, a catalyst metal layer 8 made of a catalyst metal (e.g., cobalt, nickel, iron, or an alloy containing at least one of these elements) is formed on the surface of a conductor 5 (e.g., a carbon paper serving as a gas diffusion layer described below) (step S30).

The catalyst metal layer 8 can be formed illustratively by sputtering or electroless plating. FIG. 8 schematically shows the catalyst metal layer 8 thus formed.

Next, the catalyst metal layer 8 thus formed is granulated by heating treatment (step S31).

Alternatively, as described above, it is also possible to directly attach catalyst metal particles to the surface of the conductor 5 by sputtering or electroless plating.

The heating treatment of the catalyst metal layer 8 can be performed illustratively by introducing H₂ (hydrogen) or a mixed gas containing H₂ (hydrogen) into the container 101 and heating the conductor 5. As a possible example of the processing condition for such heating treatment, the temperature of the conductor 5 is 300° C. or more and 600° C. or less, the pressure in the container 101 is approximately 800 Pa, the flow rate of H₂ (hydrogen) is approximately 80 sccm, and the processing time is approximately 10 minutes.

By such treatment, the natural oxide film of the catalyst metal can be reduced in conjunction with the granulation.

Next, continuously following this heating treatment (granulation processing), CH₄ (methane) is introduced to form a mixed gas of CH₄ (methane) and H₂ (hydrogen) in the container 101. This mixed gas is decomposed by a plasma P generated by introducing a microwave M to grow an ultrafine fibrous carbon body 2 (e.g., carbon nanotube) on the surface of the granulated catalyst metal layer 8 (step S32).

The carbon body 2 can be grown illustratively by plasma CVD (chemical vapor deposition). In plasma CVD, the plasma processing apparatus 100 described above can be used.

The following description illustrates the case of growing the carbon body 2 using the plasma processing apparatus 100 illustrated in FIG. 9. As described above, growth of the carbon body 2 can continuously follow the heating treatment (granulation processing) in the same container 101. However, the following description illustrates the case of growing the carbon body 2 on a conductor 5 with metal particles formed thereon beforehand.

A conductor 5 with metal particles (e.g., the catalyst metal layer 8 being granulated) formed on its surface is transferred into the plasma processing apparatus 100, and mounted and held on the mounting stage 106 so that the surface with metal particles formed thereon faces the generation region of the plasma P. Here, the conductor 5 with metal particles formed on its surface serves as the workpiece W described above.

Next, a mixed gas of CH₄ (methane) and H₂ (hydrogen) is introduced into the container 101 and decomposed by a plasma P generated by introducing a microwave M to grow an ultrafine fibrous carbon body 2 on the surface of the metal particles.

As a possible example of the processing condition at this time, the temperature of the conductor 5 with metal particles formed thereon is 300° C. or more and 600° C. or less, the pressure in the container 101 is approximately 800 Pa, the flow rate of CH₄ (methane) is approximately 10 sccm, the flow rate of H₂ (hydrogen) is approximately 80 sccm, the RF power is approximately 400 W, and the processing time is approximately 30 minutes. The plasma P is of the microwave excitation type.

By plasma CVD processing under the illustrated processing condition, an ultrafine fibrous carbon body 2 (e.g., carbon nanotube) is grown on the surface of the granulated catalyst metal layer 8 (e.g., granulated nickel layer). This carbon body 2 includes a nucleus made of the catalyst metal.

In the case of the catalyst layer 1 illustrated in FIG. 1, subsequently, sulfonization (step S3) and the step of allowing the catalyst to be supported (step S4) illustrated in FIG. 5 can be performed (step S33).

In the case of the catalyst layer 1a illustrated in FIG. 2, subsequently, an ultrafine fibrous carbon body 3 can be further grown.

As described above, sulfonization for surface modification (step S3) can be omitted. However, if sulfonization (surface modification) is performed so that protons (H⁺) can be conducted, the conduction path of protons (H⁺) can be effectively formed as described above. Furthermore, it is possible to provide stable power generation with little temporal variation, being resistant to the effect of expansion and shrinkage associated with changes in temperature and other external environment.

Next, the case of growing the carbon body 3 is illustrated.

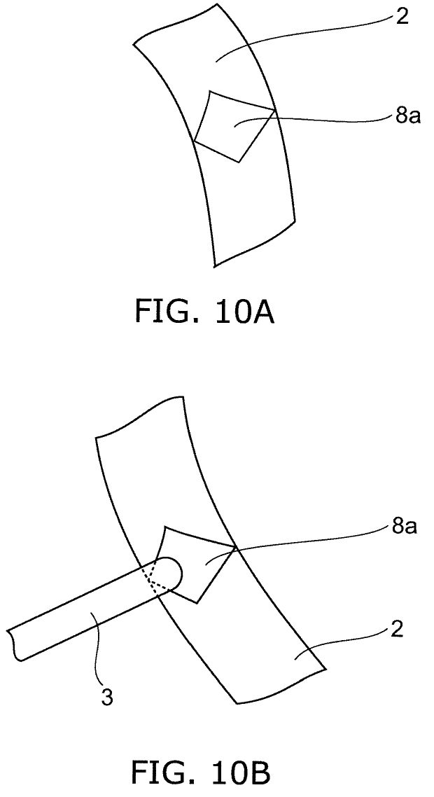

FIG. 10 is a schematic view for illustrating a carbon body 2 with a catalyst metal particle formed on its surface. Here, FIG. 10A is a schematic view for illustrating a catalyst metal particle formed on the surface of a carbon body 2, and FIG. 10B is a schematic view for illustrating the growth of another carbon body from the catalyst metal particle. While FIG. 10 illustrates a “solid” carbon body, the same applies to a “tubular” carbon body.

To grow another carbon body 3 from the carbon body 2 grown as described above, first, a catalyst metal particle 8a needs to be formed on the surface of the carbon body 2. The catalyst metal particle 8a can be formed, like that described above, by forming a catalyst metal layer using sputtering or electroless plating and granulating it by heating treatment. Alternatively, a catalyst metal particle 8a can be directly attached to the surface of the carbon body 2 using sputtering or electroless plating.

The method for heating treatment (granulation processing), the processing condition, and the effect resulting therefrom are the same as those described above, and hence the description thereof is omitted.

Then, the catalyst layer 1a illustrated in FIG. 2 can be obtained by growing another carbon body 3 from this catalyst metal particle 8a and, for example, by performing step S3 and step S4 illustrated in FIG. 5. The growth of the carbon body 3 can also be based on plasma CVD, and hence the detailed description thereof is omitted.

The shape of the carbon body 2 and the carbon body 3 can be varied by adjusting the condition for plasma processing described above.

Here, the inventors have found preferable that, when an ultrafine fibrous carbon body is grown, the surface with catalyst metal particles formed thereon is not directly exposed to the plasma. Then, the carbon body can be grown rapidly and reliably. The cause thereof is not exactly clear, but it is considered that exposure to ions emitted from the plasma P may interfere with the growth of the carbon body.

The surface with catalyst metal particles formed thereon can be prevented from being directly exposed to the plasma, for example, by disposing a shield facing the surface with catalyst metal particles formed thereon.

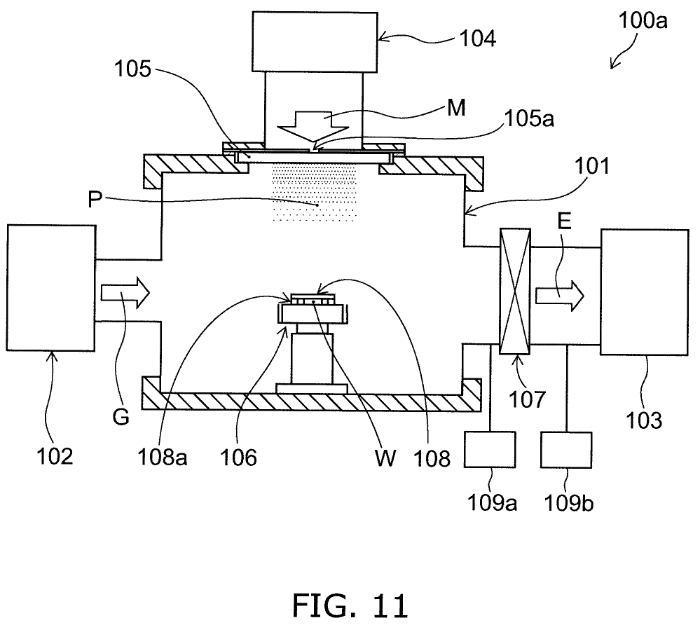

FIG. 11 is a schematic view for illustrating a plasma processing apparatus provided with a shield. The same elements as those illustrated in FIG. 9 are labeled with like reference numerals, and the description thereof is omitted.

As shown in FIG. 11, the plasma processing apparatus 100a includes a shield 108 facing the mounting surface of the mounting stage 106. A supporting section 108a for supporting the shield 108 is provided at the periphery of the shield 108. The supporting section 108a can also be provided with an elevating means, not shown, for moving up and down the shield 108.

The shield 108 is disposed at such a position as to cover the major surface of the workpiece W mounted on the mounting stage 106. Here, the major surface of the shield 108 may abut the major surface (the surface with catalyst metal particles formed thereon) of the workpiece W, or a gap may be provided between these major surfaces.

In the case where the major surfaces abut each other, the supporting section 108a is not necessarily needed, but a plate-like shield can be illustratively mounted on the major surface (the surface with catalyst metal particles formed thereon) of the workpiece W.

The inventors have found that the carbon body can be grown more rapidly and reliably if the shield 108 is made of an insulator. Here, the insulator can illustratively be quartz, glass, or alumina or other ceramics. In view of productivity, among various insulators, it is preferable to select an insulator having high plasma resistance.

According to this embodiment, the carbon body can be grown rapidly and reliably. In particular, if a shield 108 or the like is used to avoid direct exposure to the plasma P, the carbon body can be grown more rapidly and reliably.

The invention is not limited to the above embodiment, but its components can be modified without departing from the spirit of the invention.

For example, while a mixed gas of CH₄ (methane) and H₂ (hydrogen) is illustrated as a source gas, it can be suitably modified to grow a carbon body. Such a source gas can illustratively be a carbon-based gas such as CH₄ (methane), C₂H₄ (ethylene), and C₂H₂ (acetylene), tetraethoxysilane, or a mixed gas of the above carbon-based gas and hydrogen gas. Alternatively, the source gas can be a vaporized gas of methanol, ethanol, acetone, or toluene, or a mixed gas of the above vaporized gas and hydrogen gas.

The processing condition described above can be suitably modified depending on the plasma processing apparatus and the gas used.

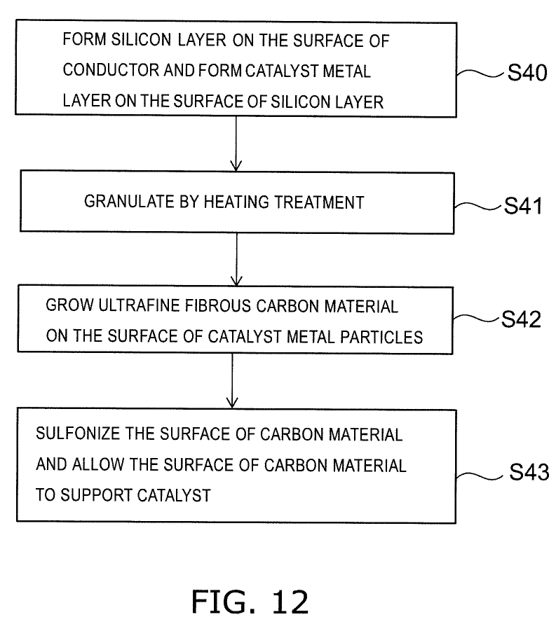

FIG. 12 is a flow chart for illustrating a method for manufacturing a supported catalyst according to an eighth embodiment of the invention.

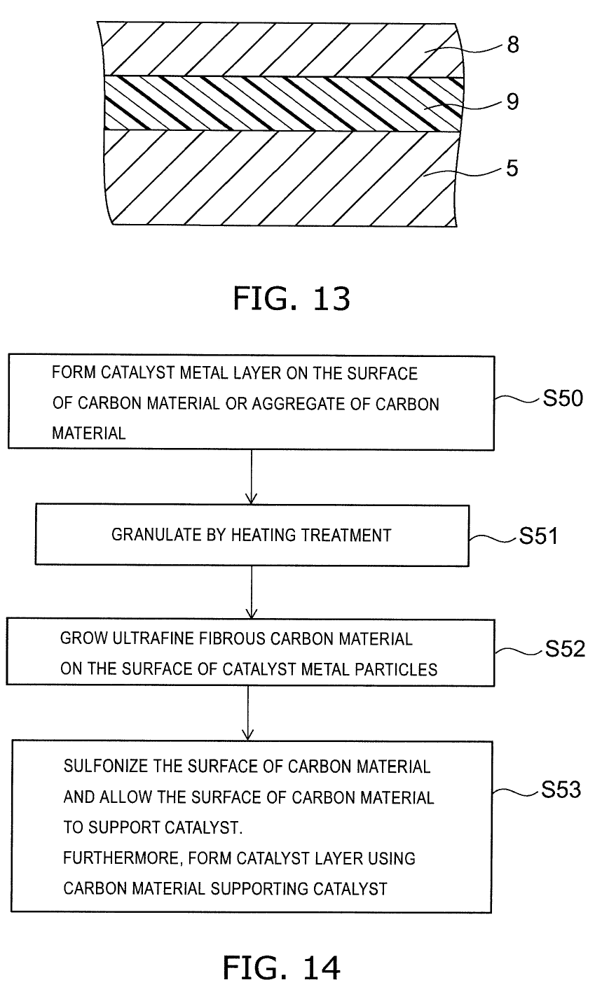

FIG. 13 is a schematic cross-sectional view of a layer structure for illustrating a conductor with a silicon layer and a catalyst metal layer formed thereon.

Like the embodiment illustrated in FIG. 7, this embodiment illustrates a method for manufacturing the catalyst layer 1, 1a. Hence, the description of the same elements as those in FIG. 7 is omitted as appropriate.

When an ultrafine fibrous carbon body is grown on the surface of the catalyst metal particle and the surface of the carbon body is modified (sulfonized), the grown carbon body may detach from the conductor 5.

As a result of study, the inventors have found that the detachment of the carbon body during modification can be prevented by providing a silicon layer as a foundation of the catalyst metal layer and applying heating treatment thereto for granulation.

Thus, in this embodiment, first, as shown in FIG. 13, a silicon layer 9 made of silicon is formed on the surface of a conductor 5 (e.g., a carbon paper serving as a gas diffusion layer described below), and a catalyst metal layer 8 made of a catalyst metal (e.g., cobalt, nickel, iron, or an alloy containing at least one of these elements) is formed on the surface of the silicon layer 9 (step S40).

The silicon layer 9 can be formed illustratively by sputtering. The catalyst metal layer 8 can be formed illustratively by sputtering or electroless plating.

Next, like that described above, granulation is performed by heating treatment (step S41).

At this time, the catalyst metal layer 8 is silicidized, or forms a mixed layer with silicon.

Although not exactly clear, a mixed layer of the foundation material and silicon may be formed at the interface between the foundation (the carbon body 2, 6, 7 or the conductor 5) and the silicon layer 9.

By such treatment, the adhesive force can be increased, and hence the detachment of the carbon body during modification can be prevented.

The method for heating treatment (granulation processing), the processing condition, and the effect resulting therefrom are the same as those described above, and hence the description thereof is omitted.

Here, although not exactly clear, it is considered that the increase of adhesive force occurs at either or both of the interface between the catalyst metal layer (or catalyst metal particle) and the silicon layer (the silicidized portion or the portion where a mixed layer with silicon is formed) and the interface between the foundation (the carbon body 2, 6, 7 or the conductor 5) and the silicon layer.

Next, an ultrafine fibrous carbon body 2 (e.g., carbon nanotube) is grown on the surface (step S42).

The carbon body 2 can be grown illustratively by plasma CVD (chemical vapor deposition). In plasma CVD, the plasma processing apparatus 100 or the plasma processing apparatus 100a described above can be used. The processing condition can also be the same as that illustrated with reference to FIG. 7.

Here, in the case of the catalyst layer 1 illustrated in FIG. 1, subsequently, sulfonization (step S3) and the step of allowing the catalyst to be supported (step S4) illustrated in FIG. 5 can be performed (step S43).

In the case of the catalyst layer 1a illustrated in FIG. 2, subsequently, like that described above, catalyst metal particles can be grown on the surface of the carbon body 2, and an ultrafine fibrous carbon body 3 can be further grown from the catalyst metal particles. The carbon body 3 can also be grown in the same manner as illustrated with reference to FIG. 10, and hence the detailed description thereof is omitted. Also in the case of growing the carbon body 3, a silicon layer can be provided as a foundation of the catalyst metal layer, and heating treatment can be applied thereto for granulation to increase the adhesive force.

Here, as described above, sulfonization for surface modification (step S3) can be omitted. However, if sulfonization (surface modification) is performed so that protons (H⁺) can be conducted, the conduction path of protons (H⁺) can be effectively formed as described above. Furthermore, it is possible to provide stable power generation with little temporal variation, being resistant to the effect of expansion and shrinkage associated with changes in temperature and other external environment.

Furthermore, the shape of the carbon body 2 and the carbon body 3 can be varied by adjusting the condition for plasma processing described above.

According to this embodiment, the detachment of the carbon body 2 and the carbon body 3 during surface modification (sulfonization) can be prevented.

FIG. 14 is a flow chart for illustrating a method for manufacturing a supported catalyst according to a ninth embodiment of the invention.

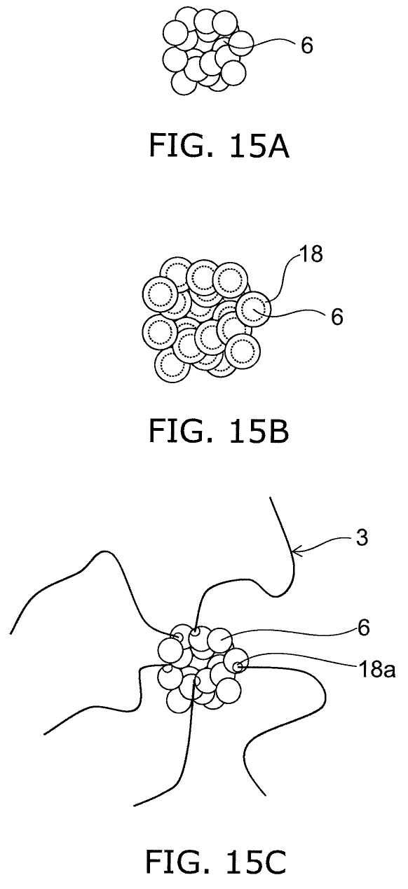

FIG. 15 is a schematic view for illustrating growth of a carbon body.

Like the embodiment illustrated in FIG. 6, this embodiment illustrates a method for manufacturing the catalyst layer 1b, 1c. Hence, the description of the same elements as those in FIG. 6 is omitted as appropriate. Furthermore, for convenience of description, a particulate carbon body 6 with an ultrafine fibrous carbon body provided on its surface (the catalyst layer 1b illustrated in FIG. 3) is illustrated. However, this embodiment is also applicable to a manufacturing method in which the particulate carbon body 6 is replaced by a linear carbon body 7 (the catalyst layer 1c illustrated in FIG. 4).

First, a catalyst metal layer 18 made of a catalyst metal (e.g., cobalt, nickel, iron, or an alloy containing at least one of these elements) is formed on the surface of a particulate carbon body 6 or an aggregate of the carbon body 6 (step S50).

The catalyst metal layer 18 can be formed illustratively by sputtering or electroless plating.

Here, FIG. 15A shows an aggregate of the carbon body 6, and FIG. 15B shows the aggregate of the carbon body 6 with a catalyst metal layer 18 formed on its surface.

Next, like that illustrated with reference to FIG. 7, the catalyst metal layer 18 is granulated (into catalyst metal particles 18a) by heating treatment (step S51).

The method for heating treatment (granulation processing), the processing condition, and the effect resulting therefrom are the same as those described above, and hence the description thereof is omitted.

Next, an ultrafine fibrous carbon body 3 (e.g., carbon nanotube) is grown on the surface of the catalyst metal particles 18a (step S52).

The carbon body 3 can be grown illustratively by plasma CVD (chemical vapor deposition). In plasma CVD, the plasma processing apparatus 100 or the plasma processing apparatus 100a described above can be used.

Here, FIG. 15C shows the carbon body 3 being grown.

The source gas can be a mixed gas of CH₄ (methane) and H₂ (hydrogen) like that illustrated with reference to FIG. 7. The processing condition can also be the same as that illustrated with reference to FIG. 7.

By this plasma CVD processing, an ultrafine fibrous carbon body 3 (e.g., carbon nanotube) can be grown on the surface of the catalyst metal particles 18a. This carbon body 3 includes a nucleus made of the catalyst metal like that described above.

Subsequently, sulfonization (step S12), the step of allowing the catalyst to be supported (step S13), and formation of the catalyst layer (step S14) illustrated in FIG. 6 are performed (step S53).

As described above, sulfonization for surface modification (step S12) can be omitted. However, if sulfonization (surface modification) is performed so that protons (H⁺) can be conducted, the conduction path of protons (H⁺) can be effectively formed as described above. Furthermore, it is possible to provide stable power generation with little temporal variation, being resistant to the effect of expansion and shrinkage associated with changes in temperature and other external environment.

Furthermore, as described above, by providing a silicon layer as a foundation of the catalyst metal layer, detachment of the carbon body during modification can be prevented.

Furthermore, by avoiding direct exposure to the plasma during growing the carbon body 3, the carbon body 3 can be grown rapidly and reliably.

Next, a fuel cell provided with the catalyst layer according to the present embodiments is illustrated.

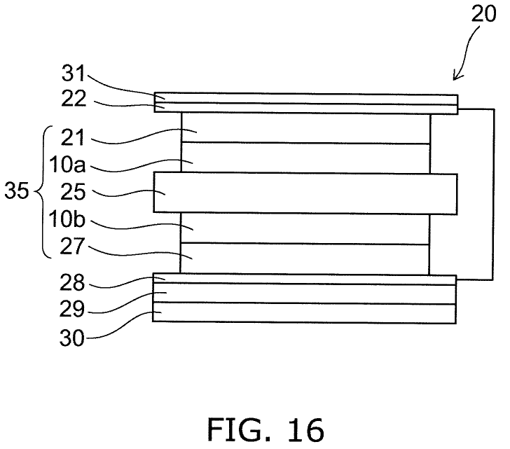

FIG. 16 is a schematic view for illustrating a fuel cell according to a tenth embodiment of the invention.

For convenience of description, a direct methanol fuel cell (DMFC), which uses methanol as a fuel, is taken as an example.

As shown in FIG. 16, the fuel cell 20 has a membrane electrode assembly (MEA) 35 as an electromotive section. The membrane electrode assembly 35 includes a fuel electrode composed of a catalyst layer 10b according to the present embodiments and a gas diffusion layer 27, an air electrode composed of a catalyst layer 10a according to the present embodiments and a gas diffusion layer 21, and a polymer solid electrolyte membrane 25 held between the catalyst layer 10b of the fuel electrode and the catalyst layer 10a of the air electrode.

The catalyst layer 10a and the catalyst layer 10b can illustratively be the catalyst layer 1, the catalyst layer 1a, the catalyst layer 1b, or the catalyst layer 1c described above. It is also possible to use the catalyst layer according to the present embodiments for at least one of the catalyst layer of the fuel electrode and the catalyst layer of the air electrode. However, the cell characteristics can be further improved by using the catalyst layer according to the present embodiments for both of them.

The catalyst 4 of the catalyst layer 10b only needs to be able to oxidize an organic fuel, and can illustratively include fine particles made of a solid solution of platinum with at least one metal selected from the group consisting of iron, nickel, cobalt, tin, ruthenium, and gold.

The catalyst 4 of the catalyst layer 10a only needs to cause a reduction reaction, and can illustratively include a platinum-group element. For example, it can include an elemental metal such as platinum, ruthenium, rhodium, iridium, osmium, and palladium, and a solid solution containing a platinum-group element. The solid solution containing a platinum-group element can illustratively be a platinum-nickel solid solution.

However, the invention is not limited thereto, but the material can be suitably modified.

The polymer solid electrolyte membrane 25 can be primarily composed of a proton conductive material, which can illustratively be a polymer solid electrolyte material such as a fluorine-based resin having a sulfonic acid group (e.g., a perfluorosulfonic acid polymer) or a hydrocarbon-based resin having a sulfonic acid group. However, the invention is not limited thereto, but the material can be suitably modified.

Here, the polymer solid electrolyte membrane 25 can be a membrane made of a porous material having through holes or a membrane made of an inorganic material having openings, in which the through holes or openings are filled with a polymer solid electrolyte material, or can be a membrane made of a polymer solid electrolyte material.

The gas diffusion layer 27 provided on the surface of the catalyst layer 10b of the fuel electrode serves to uniformly supply fuel to the catalyst layer 10b.

The gas diffusion layer 21 provided on the surface of the catalyst layer 10a of the air electrode serves to uniformly supply oxygen to the catalyst layer 10a, and also serves to adjust the degree of permeation of water produced in the catalyst layer 10a (drainability and moisture retention).

A conductive layer 28 is laminated on the gas diffusion layer 27 of the fuel electrode, and a conductive layer 22 is laminated on the gas diffusion layer 21 of the air electrode. The conductive layer 28 and the conductive layer 22 can be illustratively made of a porous layer such as a mesh of gold or other conductive metal material, or a gold foil having a plurality of openings. The conductive layer 22 and the conductive layer 28 are electrically connected to each other through a load, not shown.

The conductive layer 28 on the fuel electrode side is connected to a liquid fuel tank 30 serving as a fuel supply section through a gas-liquid separation membrane 29. The gas-liquid separation membrane 29 serves as a vapor-phase fuel permeation membrane, which is only permeable to the vaporized component of liquid fuel and not permeable to the liquid fuel.

The gas-liquid separation membrane 29 is disposed so as to occlude the opening, not shown, provided to extract the vaporized component of liquid fuel in the liquid fuel tank 30. The gas-liquid separation membrane 29 separates the vaporized component of the fuel from the liquid fuel and also vaporizes the liquid fuel, and can be illustratively made of silicone rubber or other material.

Further on the liquid fuel tank 30 side of the gas-liquid separation membrane 29, it is possible to provide a permeability adjusting membrane, not shown, having a gas-liquid separation function like the gas-liquid separation membrane 29 and adjusting the permeated amount of the vaporized component of fuel. The permeated amount of the vaporized component through this permeability adjusting membrane is adjusted by varying the opening ratio of the permeability adjusting membrane. This permeability adjusting membrane can be illustratively made of polyethylene terephthalate or other material. Such a permeability adjusting membrane allows gas-liquid separation of fuel and adjustment of the amount of the vaporized component of fuel supplied to the catalyst layer 10b side of the fuel electrode.

The liquid fuel stored in the liquid fuel tank 30 can be a methanol aqueous solution having a concentration exceeding 50 mole % or pure methanol. The purity of pure methanol can be 95 weight % or more and 100 weight % or less. The vaporized component of liquid fuel illustratively refers to vaporized methanol in the case of using pure methanol as the liquid fuel, and to an air-fuel mixture of the vaporized component of methanol and the vaporized component of water in the case of using a methanol aqueous solution as the liquid fuel.

On the other hand, a cover 31 is laminated to the conductive layer 22 of the air electrode. The cover 31 is provided with a plurality of air inlets, not shown, for taking in air (oxygen) as an oxidizer. The cover 31 also serves to pressurize the membrane electrode assembly 35 to enhance adhesion therein, and hence can be illustratively made of metal such as SUS304.

Next, the function of the fuel cell 20 according to this embodiment is illustrated.

The methanol aqueous solution (liquid fuel) in the liquid fuel tank 30 is vaporized to generate an air-fuel mixture of vaporized methanol and steam, which permeates the gas-liquid separation membrane 29. Then, the air-fuel mixture further passes through the conductive layer 28, is diffused in the gas diffusion layer 27, and is supplied to the catalyst layer 10b. The air-fuel mixture supplied to the catalyst layer 10b undergoes the oxidation reaction given by the following formula (1):

CH₃OH+H₂O→CO₂+6H⁺+6e⁻ (1)

In the case of using pure methanol as the liquid fuel, no steam is supplied from the liquid fuel tank 30. Hence, the oxidation reaction of the above formula (1) is caused by methanol with the water generated in the catalyst layer 10a of the air electrode, described below, and the water in the polymer solid electrolyte membrane 25.

Protons (H⁺) produced by the oxidation reaction of the above formula (1) are conducted in the polymer solid electrolyte membrane 25 and reach the catalyst layer 10a of the air electrode. Electrons (e⁻) produced by the oxidation reaction of the above formula (1) are supplied from the conductive layer 28 to a load, not shown, do work therein, and then reach the catalyst layer 10a through the conductive layer 22 and the gas diffusion layer 21.

On the other hand, air (oxygen) taken in through the air inlets, not shown, of the cover 31 permeates the conductive layer 22, is diffused in the gas diffusion layer 21, and is supplied to the catalyst layer 10a. Oxygen in the air supplied to the catalyst layer 10a reacts with protons (H⁺) and electrons (e⁻), which have reached the catalyst layer 10a, by the following formula (2) to produce water:

$$\frac{3}{2} {O}_{2} + 6 {H}^{+} + 6 {e}^{-} \to 3 {H}_{2} O \qquad ( 2 )$$

Part of the water generated in the catalyst layer 10a of the air electrode by this reaction permeates the gas diffusion layer 21 to reach vapor-liquid equilibrium inside the gas diffusion layer 21. Vaporized water is evaporated from the air inlets, not shown, of the cover 31. Water in liquid form is stored in the catalyst layer 10a of the air electrode.

As the reaction of formula (2) proceeds, the amount of produced water increases, and the amount of moisture stored in the catalyst layer 10a of the air electrode increases. Then, with the progress of the reaction of formula (2), the amount of moisture stored in the catalyst layer 10a of the air electrode becomes larger than the amount of moisture stored in the catalyst layer 10b of the fuel electrode.

Consequently, the water produced in the catalyst layer 10a of the air electrode migrates by osmosis through the polymer solid electrolyte membrane 25 to the catalyst layer 10b of the fuel electrode. Hence, as compared with the case where the supply of moisture to the catalyst layer 10b of the fuel electrode relies only on steam vaporized from the liquid fuel tank 30, the supply of moisture is facilitated, and the reaction of the above formula (1) can be accelerated. Thus, the output density can be increased, and the increased output density can be maintained for a long period of time.

More specifically, even in the case where a methanol aqueous solution having a methanol concentration exceeding 50 mole % or pure methanol is used as a liquid fuel, the water which has migrated from the catalyst layer 10a of the air electrode to the catalyst layer 10b of the fuel electrode can be used for the reaction of the above formula (1). Furthermore, reaction resistance to the reaction of the above formula (1) can be further reduced to improve long-term output characteristics and load current characteristics. Moreover, the liquid fuel tank 30 can be downsized. Furthermore, high proton (H⁺) conductivity can be achieved because the polymer solid electrolyte membrane 25 can be moistened.

According to this embodiment, the conduction path of electrons (e⁻) to the catalyst 4 can be formed more reliably. Furthermore, by surface modification of the carbon body 2, the conduction path of protons (H⁺) can be effectively formed. Furthermore, by providing a carbon body 3 having a small size, the area (surface area) supporting the catalyst 4 can be extended, and the amount of catalyst 4 can be increased by that amount. Furthermore, by surface modification of the carbon body 3, proton conduction in the vicinity of the catalyst 4 can be performed more reliably. Hence, the utilization efficiency of the catalyst 4 can be improved, and the reactions of the above formulas (1) and (2) can be performed efficiently and stably.

Furthermore, because the conduction path of protons (H⁺) is formed by surface modification of the carbon body, it is possible to provide stable power generation with little temporal variation, being resistant to the effect of expansion and shrinkage associated with changes in temperature and other external environment.

The liquid fuel tank 30 of this fuel cell 20 was injected with 5 milliliters of pure methanol (95 weight % or more), and the maximum output was measured from the current and voltage value in an environment at a temperature of 25° C. and a relative humidity of 50%. Furthermore, the maximum surface temperature was measured by a thermocouple attached to the surface of the fuel cell. The catalyst layer was the catalyst layer 1 illustrated in FIG. 1.

As a result of this measurement, the maximum output was 24.2 mW/cm², and the maximum surface temperature of the fuel cell was 33.4° C.

A similar measurement was made on a fuel cell provided with a catalyst layer composed only of a particulate carbon body having a prescribed average particle diameter. The maximum output in this measurement was 20.1 mW/cm². Thus, it was confirmed that the catalyst layer according to this embodiment can increase the maximum output by approximately 20%.

Furthermore, a 500-hour endurance test was also performed. As a result, the output variation was within 10% for the fuel cell provided with the catalyst layer according to this embodiment, whereas the output variation was 23% for the fuel cell provided with a catalyst layer composed only of a carbon body having a prescribed average particle diameter. Thus, the superiority of this embodiment was confirmed also in durability.

By performing similar measurements on the catalyst layers 1a to 1c illustrated in FIGS. 2 to 4, similar measurement results were confirmed.

Next, a method for manufacturing the fuel cell 20 according to the present embodiments is illustrated.

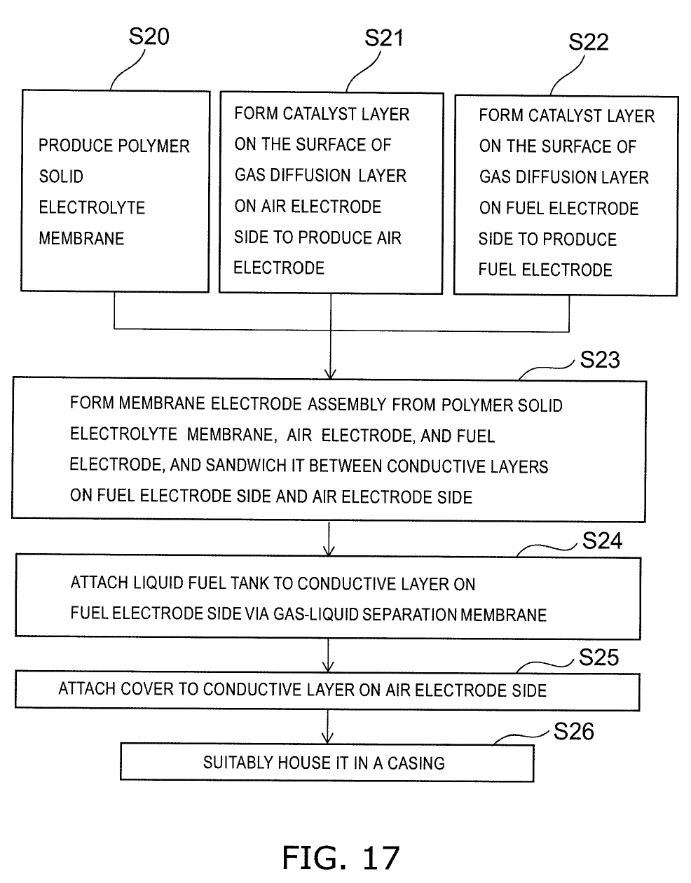

FIG. 17 is a flow chart for illustrating a method for manufacturing a fuel cell according to an eleventh embodiment of the invention.

First, a porous material membrane is produced using chemical or physical methods such as the phase separation method, the foaming method, and the sol-gel method. The porous material membrane can be suitably based on commercially available porous materials. For example, a polyimide porous membrane having a thickness of 25 μm and an opening ratio of 45% (UPILEX-PT™, manufactured by Ube Industries, Ltd.) can be used.

A polymer solid electrolyte is filled in this porous material membrane to produce a polymer solid electrolyte membrane 25 (step S20).

The method for filling the polymer solid electrolyte can illustratively include immersing the porous material membrane in a polymer solid electrolyte solution, and pulling it up and drying it to remove the solvent. The polymer solid electrolyte solution can illustratively be a Nafion® (manufactured by DuPont) solution. Alternatively, the polymer solid electrolyte membrane 25 can be a membrane made of a polymer electrolyte material. In this case, there is no need to produce a porous material membrane and fill a polymer solid electrolyte therein.

Next, on the basis of the method for manufacturing a catalyst layer according to the above embodiment, a catalyst layer 10a is formed on the surface of the gas diffusion layer 21 on the air electrode side to produce an air electrode (step S21).

On the other hand, on the basis of the method for manufacturing a catalyst layer according to the above embodiment, a catalyst layer 10b is formed on the surface of the gas diffusion layer 27 on the fuel electrode side to produce a fuel electrode (step S22).

Here, it is also possible to use the catalyst layer according to the present embodiments for at least one of the catalyst layer of the fuel electrode and the catalyst layer of the air electrode. However, the cell characteristics can be further improved by using the catalyst layer according to the present embodiments for both of them.

Next, a membrane electrode assembly 35 is formed from the polymer solid electrolyte membrane 25, the air electrode (catalyst layer 10a and gas diffusion layer 21), and the fuel electrode (catalyst layer 10b and gas diffusion layer 27), and sandwiched between a conductive layer 28 and a conductive layer 22, which are illustratively made of gold foil having a plurality of openings for taking in vaporized methanol or air (step S23).

Next, a liquid fuel tank 30 is attached to the conductive layer 28 via a gas-liquid separation membrane 29 (step S24).

The gas-liquid separation membrane 29 can be illustratively made of a silicone sheet.

Next, a cover 31 is attached to the conductive layer 22 (step S25).

The cover 31 can be illustratively made of a stainless steel plate (SUS304), which has air inlets, not shown, for taking in air.

Finally, this is suitably housed in a casing to form a fuel cell 20 (step S26).

The embodiments of the invention have been illustrated. However, the invention is not limited to the above description.

The above embodiments can be suitably modified by those skilled in the art, and such modifications are also encompassed within the scope of the invention as long as they fall within the spirit of the invention.

For example, the shape, dimension, material, layout, and number of the elements included in the catalyst layer 1, the catalyst layer 1a, the catalyst layer 1b, the catalyst layer 1c, the fuel cell 20, the plasma processing apparatus 100, and the plasma processing apparatus 100a described above are not limited to those illustrated, but can be suitably modified.

With regard to the fuel, a methanol aqueous solution is taken as an example. However, the fuel is not limited thereto. Besides methanol, other fuels can include alcohols such as ethanol and propanol, ethers such as dimethyl ether, cycloparaffins such as cyclohexane, and cycloparaffins having a hydrophilic group such as a hydroxy group, carboxyl group, amino group, and amido group. Such fuel is typically used as an aqueous solution with approximately 5 to 90 weight %.

The elements included in the above embodiments can be combined as long as feasible, and such combinations are also encompassed within the scope of the invention as long as they fall within the spirit of the invention.

1. A supported catalyst comprising:
a catalyst; and
a carbon body,
the catalyst being supported on the carbon body, and
the carbon body being linear.

2. A supported catalyst comprising:
a catalyst;
a linear first carbon body supporting the catalyst; and
a linear second carbon body,
one end of the first carbon body being electrically connected to the second carbon body.

3. A supported catalyst comprising:
a catalyst;
a linear first carbon body supporting the catalyst; and
a particulate second carbon body,
one end of the first carbon body being electrically connected to the second carbon body.

4. A supported catalyst configured in a layer structure, comprising:
a catalyst;
a linear first carbon body supporting the catalyst; and
a second carbon body,
one end of the first carbon body being electrically connected to the second carbon body, and
part of the second carbon body reaching a surface of the layer structure.

5. The supported catalyst according to claim 1, wherein a surface of the carbon body is modified with a substituent group capable of supplying a proton by dissociation.

6. The supported catalyst according to claim 2, wherein, with regard to surfaces of the first carbon body and the second carbon body, at least the surface of the second carbon body is modified with a substituent group capable of supplying a proton by dissociation.

7. The supported catalyst according to claim 3, wherein, with regard to surfaces of the first carbon body and the second carbon body, at least the surface of the second carbon body is modified with a substituent group capable of supplying a proton by dissociation.

8. The supported catalyst according to claim 4, wherein a surface of the second carbon body is modified with a substituent group capable of supplying a proton by dissociation.

9. The supported catalyst according to claim 5, wherein the modification with the substituent group includes sulfonization.

10. The supported catalyst according to claim 6, wherein the modification with the substituent group includes sulfonization.

11. The supported catalyst according to claim 7, wherein the modification with the substituent group includes sulfonization.

12. The supported catalyst according to claim 8, wherein the modification with the substituent group includes sulfonization.

13. The supported catalyst according to claim 5, wherein the substituent group is at least one or more selected from the group consisting of a carboxyl group, a sulfonyl group, an amino group, a nitro group, and a sulfo group.

14. The supported catalyst according to claim 6, wherein the substituent group is at least one or more selected from the group consisting of a carboxyl group, a sulfonyl group, an amino group, a nitro group, and a sulfo group.

15. The supported catalyst according to claim 7, wherein the substituent group is at least one or more selected from the group consisting of a carboxyl group, a sulfonyl group, an amino group, a nitro group, and a sulfo group.

16. The supported catalyst according to claim 8, wherein the substituent group is at least one or more selected from the group consisting of a carboxyl group, a sulfonyl group, an amino group, a nitro group, and a sulfo group.

17. A method for manufacturing a supported catalyst, comprising:
attaching a first catalyst metal particle on a surface of a conductor;
forming a linear first carbon body on a surface of the first catalyst metal particle; and
allowing the first carbon body to support a catalyst.

18. The method for manufacturing a supported catalyst according to claim 17, further comprising:
modifying a surface of the first carbon body with a substituent group capable of supplying a proton by dissociation.

19. The method for manufacturing a supported catalyst according to claim 17, further comprising:
attaching a second catalyst metal particle on a surface of the first carbon body;
forming a linear second carbon body on a surface of the second catalyst metal particle; and
allowing the second carbon body to support a catalyst.

20. The method for manufacturing a supported catalyst according to claim 19, further comprising:
modifying a surface of the second carbon body with a substituent group capable of supplying a proton by dissociation.

21. A method for manufacturing a supported catalyst, comprising:
attaching a first catalyst metal particle on a surface of a first carbon body;
forming a linear second carbon body on a surface of the first catalyst metal particle;
allowing the second carbon body to support a catalyst; and
immersing the first carbon body and the second carbon body in a solid polymer electrolyte solution.

22. The method for manufacturing a supported catalyst according to claim 21, further comprising:
modifying a surface of the first carbon body and the second carbon body with a substituent group capable of supplying a proton by dissociation.

23. A method for manufacturing a supported catalyst, comprising:
forming a first catalyst metal layer on a surface of a conductor;
granulating the first catalyst metal layer by heating treatment;
forming a linear first carbon body on a surface of the granulated first catalyst metal layer; and
allowing the first carbon body to support a catalyst.

24. The method for manufacturing a supported catalyst according to claim 23, further comprising:
modifying a surface of the first carbon body with a substituent group capable of supplying a proton by dissociation.

25. A method for manufacturing a supported catalyst, comprising:
forming a silicon layer on a surface of a conductor;
forming a catalyst metal layer on a surface of the silicon layer;
granulating the silicon layer and the catalyst metal layer by heating treatment;
forming a linear carbon body on a surface of the granulated layers; and
allowing the carbon body to support a catalyst.

26. The method for manufacturing a supported catalyst according to claim 25, further comprising:
modifying a surface of the carbon body with a substituent group capable of supplying a proton by dissociation.

27. A method for manufacturing a supported catalyst, comprising:
forming a catalyst metal layer on a surface of a first carbon body or an aggregate of the first carbon bodies;
granulating the catalyst metal layer by heating treatment;
forming a linear second carbon body on a surface of the granulated catalyst metal layer;
allowing the second carbon body to support a catalyst; and
immersing the first carbon body and the second carbon body in a solid polymer electrolyte solution.

28. The method for manufacturing a supported catalyst according to claim 27, further comprising:
modifying a surface of the first carbon body and the second carbon body with a substituent group capable of supplying a proton by dissociation.

29. A method for manufacturing a supported catalyst, comprising:
forming a silicon layer on a surface of a first carbon body or an aggregate of the first carbon bodies;
forming a catalyst metal layer on a surface of the silicon layer;
granulating the silicon layer and the catalyst metal layer by heating treatment;
forming a linear second carbon body on a surface of the granulated layers;
allowing the second carbon body to support a catalyst; and
immersing the first carbon body and the second carbon body in a solid polymer electrolyte solution.

30. The method for manufacturing a supported catalyst according to claim 29, further comprising:
modifying a surface of the first carbon body and the second carbon body with a substituent group capable of supplying a proton by dissociation.

31. The method for manufacturing a supported catalyst according to claim 18, wherein the modification with the substituent group includes sulfonization.

32. The method for manufacturing a supported catalyst according to claim 22, wherein the substituent group is at least one or more selected from the group consisting of a carboxyl group, a sulfonyl group, an amino group, a nitro group, and a sulfo group.

33. The method for manufacturing a supported catalyst according to claim 24, wherein the substituent group is at least one or more selected from the group consisting of a carboxyl group, a sulfonyl group, an amino group, a nitro group, and a sulfo group.

34. The method for manufacturing a supported catalyst according to claim 26, wherein the substituent group is at least one or more selected from the group consisting of a carboxyl group, a sulfonyl group, an amino group, a nitro group, and a sulfo group.

35. The method for manufacturing a supported catalyst according to claim 28, wherein the substituent group is at least one or more selected from the group consisting of a carboxyl group, a sulfonyl group, an amino group, a nitro group, and a sulfo group.

36. The method for manufacturing a supported catalyst according to claim 30, wherein the substituent group is at least one or more selected from the group consisting of a carboxyl group, a sulfonyl group, an amino group, a nitro group, and a sulfo group.

37. The method for manufacturing a supported catalyst according to claim 18, wherein the substituent group is at least one or more selected from the group consisting of a carboxyl group, a sulfonyl group, an amino group, a nitro group, and a sulfo group.

38. The method for manufacturing a supported catalyst according to claim 22, wherein the substituent group is at least one or more selected from the group consisting of a carboxyl group, a sulfonyl group, an amino group, a nitro group, and a sulfo group.

39. The method for manufacturing a supported catalyst according to claim 24, wherein the substituent group is at least one or more selected from the group consisting of a carboxyl group, a sulfonyl group, an amino group, a nitro group, and a sulfo group.

40. The method for manufacturing a supported catalyst according to claim 26, wherein the substituent group is at least one or more selected from the group consisting of a carboxyl group, a sulfonyl group, an amino group, a nitro group, and a sulfo group.

41. The method for manufacturing a supported catalyst according to claim 28, wherein the substituent group is at least one or more selected from the group consisting of a carboxyl group, a sulfonyl group, an amino group, a nitro group, and a sulfo group.

42. The method for manufacturing a supported catalyst according to claim 30, wherein the substituent group is at least one or more selected from the group consisting of a carboxyl group, a sulfonyl group, an amino group, a nitro group, and a sulfo group.

43. A fuel cell comprising:
a fuel electrode to be supplied with a fuel;
an air electrode to be supplied with an oxidizer; and
a polymer solid electrolyte membrane sandwiched between the fuel electrode and the air electrode,
at least one of supported catalysts provided respectively on the fuel electrode and the air electrode being the supported catalyst including:
a catalyst; and
a carbon body,
the catalyst being supported on the carbon body, and
the carbon body being linear.

44. A fuel cell comprising:
a fuel electrode to be supplied with a fuel;
an air electrode to be supplied with an oxidizer; and
a polymer solid electrolyte membrane sandwiched between the fuel electrode and the air electrode,
at least one of supported catalysts provided respectively on the fuel electrode and the air electrode is the supported catalyst including:
a catalyst;
a linear first carbon body supporting the catalyst; and
a linear second carbon body,
one end of the first carbon body being electrically connected to the second carbon body.

45. A fuel cell comprising:
a fuel electrode to be supplied with a fuel;
an air electrode to be supplied with an oxidizer; and
a polymer solid electrolyte membrane sandwiched between the fuel electrode and the air electrode,
at least one of supported catalysts provided respectively on the fuel electrode and the air electrode is the supported catalyst including:
a catalyst;
a linear first carbon body supporting the catalyst; and
a particulate second carbon body,
one end of the first carbon body being electrically connected to the second carbon body.

46. A fuel cell comprising:
a fuel electrode to be supplied with a fuel;
an air electrode to be supplied with an oxidizer; and
a polymer solid electrolyte membrane sandwiched between the fuel electrode and the air electrode,
at least one of supported catalysts provided respectively on the fuel electrode and the air electrode is the supported catalyst including:
a catalyst;
a linear first carbon body supporting the catalyst; and
a second carbon body,
one end of the first carbon body being electrically connected to the second carbon body, and
part of the second carbon body reaching a surface of the layer structure.

47. A method for manufacturing a fuel cell, the fuel cell including a fuel electrode to be supplied with a fuel, an air electrode to be supplied with an oxidizer, and a polymer solid electrolyte membrane sandwiched between the fuel electrode and the air electrode, the method comprising:
manufacturing at least one of supported catalysts provided respectively on the fuel electrode and the air electrode by the method for manufacturing a supported catalyst, including:
attaching a first catalyst metal particle on a surface of a conductor;
forming a linear first carbon body on a surface of the first catalyst metal particle; and
allowing the first carbon body to support a catalyst.

48. A method for manufacturing a fuel cell, the fuel cell including a fuel electrode to be supplied with a fuel, an air electrode to be supplied with an oxidizer, and a polymer solid electrolyte membrane sandwiched between the fuel electrode and the air electrode, the method comprising:
manufacturing at least one of supported catalysts provided respectively on the fuel electrode and the air electrode by the method for manufacturing a supported catalyst, including:
attaching a first catalyst metal particle on a surface of a first carbon body;
forming a linear second carbon body on a surface of the first catalyst metal particle;
allowing the second carbon body to support a catalyst; and
immersing the first carbon body and the second carbon body in a solid polymer electrolyte solution.

49. A method for manufacturing a fuel cell, the fuel cell including a fuel electrode to be supplied with a fuel, an air electrode to be supplied with an oxidizer, and a polymer solid electrolyte membrane sandwiched between the fuel electrode and the air electrode, the method comprising:
manufacturing at least one of supported catalysts provided respectively on the fuel electrode and the air electrode by the method for manufacturing a supported catalyst, including:
forming a first catalyst metal layer on a surface of a conductor;
granulating the first catalyst metal layer by heating treatment;
forming a linear first carbon body on a surface of the granulated first catalyst metal layer; and
allowing the first carbon body to support a catalyst.

50. A method for manufacturing a fuel cell, the fuel cell including a fuel electrode to be supplied with a fuel, an air electrode to be supplied with an oxidizer, and a polymer solid electrolyte membrane sandwiched between the fuel electrode and the air electrode, the method comprising:
manufacturing at least one of supported catalysts provided respectively on the fuel electrode and the air electrode by the method for manufacturing a supported catalyst, including:
forming a silicon layer on a surface of a conductor;
forming a catalyst metal layer on a surface of the silicon layer;
granulating the silicon layer and the catalyst metal layer by heating treatment;
forming a linear carbon body on a surface of the granulated layers; and
allowing the carbon body to support a catalyst.

51. A method for manufacturing a fuel cell, the fuel cell including a fuel electrode to be supplied with a fuel, an air electrode to be supplied with an oxidizer, and a polymer solid electrolyte membrane sandwiched between the fuel electrode and the air electrode, the method comprising:
manufacturing at least one of supported catalysts provided respectively on the fuel electrode and the air electrode by the method for manufacturing a supported catalyst, including:
forming a catalyst metal layer on a surface of a first carbon body or an aggregate of the first carbon bodies;
granulating the catalyst metal layer by heating treatment;
forming a linear second carbon body on a surface of the granulated catalyst metal layer;
allowing the second carbon body to support a catalyst; and
immersing the first carbon body and the second carbon body in a solid polymer electrolyte solution.

52. A method for manufacturing a fuel cell, the fuel cell including a fuel electrode to be supplied with a fuel, an air electrode to be supplied with an oxidizer, and a polymer solid electrolyte membrane sandwiched between the fuel electrode and the air electrode, the method comprising:
manufacturing at least one of supported catalysts provided respectively on the fuel electrode and the air electrode by the method for manufacturing a supported catalyst including:
forming a silicon layer on a surface of a first carbon body or an aggregate of the first carbon bodies;
forming a catalyst metal layer on a surface of the silicon layer;
granulating the silicon layer and the catalyst metal layer by heating treatment;
forming a linear second carbon body on a surface of the granulated layers;
allowing the second carbon body to support a catalyst; and
immersing the first carbon body and the second carbon body in a solid polymer electrolyte solution.
